(19) United States
(12) Patent Application Publication
(10) Pub. No.: US 2025/0113274 A1
(43) Pub. Date: Apr. 3, 2025

(54) NON-TERRESTRIAL NETWORK GATEWAY

(71) Applicant: QUALCOMM Incorporated, San Diego, CA (US)

(72) Inventors: Toru UCHINO, Zushi-shi (JP); Bharat SHRESTHA, San Diego, CA (US); Umesh PHUYAL, San Diego, CA (US); Geetha Priya RAJENDRAN, Bangalore (IN); Prasad Reddy KADIRI, San Diego, CA (US)

(21) Appl. No.: 18/476,974

(22) Filed: Sep. 28, 2023

(51) Int. Cl. H04W 36/08; H04B 7/185; H04W 76/15

(52) U.S. Cl. CPC H04W 36/087; H04B 7/18541; H04W 76/15

(57) ABSTRACT

Various aspects of the present disclosure generally relate to wireless communication. In some aspects, a network node may establish a network interface link with a centralized unit (CU). The network node may establish a set of one or more network interface links with a set of one or more distributed units (DUs). The network node may receive a first communication intended for a destination node via the network interface link. The network node may transmit the first communication to a first DU of the set of one or more DUs via a first network interface link of the set of one or more network interface links. The network node may receive a second communication intended for the destination node via the network interface link. The network node may transmit, after transmitting the first communication via the first network interface link, the second communication to a second DU via a second network interface link. Numerous other aspects are described.

### FIELD OF THE DISCLOSURE

Aspects of the present disclosure generally relate to wireless communication and to techniques and apparatuses for using a non-terrestrial network gateway for managing communications between a central unit (CU) and a set of distributed units (DUs).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a network node. The method may include establishing a network interface link with a centralized unit (CU). The method may include establishing a set of one or more network interface links with a set of one or more distributed units (DUs). The method may include receiving a first communication intended for a destination node via the network interface link. The method may include transmitting the first communication to a first DU of the set of one or more DUs via a first network interface link of the set of one or more network interface links. The method may include receiving a second communication intended for the destination node via the network interface link. The method may include transmitting, after transmitting the first communication via the first network interface link, the second communication to a second DU via a second network interface link.

Some aspects described herein relate to a method of wireless communication performed by a network node. The method may include communicating with a CU. The method may include communicating with a set of one or more DUs. The method may include receiving, from the CU, an indication of a handover from a first cell associated with a first DU to a second cell associated with a second DU. The method may include transmitting, to the first DU, an indication of a user equipment (UE) context modification request associated with the first cell. The method may include receiving, from the first DU, an indication of a UE context modification response. The method may include transmitting, to the second DU, an indication of a UE context setup request associated with the second cell. The method may include receiving, from the second DU, an indication of a UE context setup response.

Some aspects described herein relate to a method of wireless communication performed by a network node. The method may include communicating with a UE via a source DU. The method may include receiving an indication of signal measurements associated with triggering a handover from the source DU to a target DU. The method may include transmitting, to one of the source DU or a target DU, a request for coordination associated with a handover. The method may include receiving, from one of the source DU or the target DU, a response to the request for the coordination.

Some aspects described herein relate to a method of wireless communication performed by a first DU. The method may include receiving, directly or indirectly from a CU, a request for coordination of a handover associated with a UE and a second DU. The method may include communicating, with the second DU, handover coordination information.

Some aspects described herein relate to a network node for wireless communication. The network node may include one or more memories and one or more processors coupled to the one or more memories. The one or more processors may be configured to cause the network node to establish a network interface link with a CU. The one or more processors may be configured to cause the network node to establish a set of one or more network interface links with a set of one or more DUs. The one or more processors may be configured to cause the network node to receive a first communication intended for a destination node via the network interface link. The one or more processors may be configured to cause the network node to transmit the first communication to a first DU of the set of one or more DUs via a first network interface link of the set of one or more network interface links. The one or more processors may be configured to cause the network node to receive a second communication intended for the destination node via the network interface link. The one or more processors may be configured to cause the network node to transmit, after transmitting the first communication via the first network interface link, the second communication to a second DU via a second network interface link.

Some aspects described herein relate to a network node for wireless communication. The network node may include one or more memories and one or more processors coupled to the one or more memories. The one or more processors may be configured to cause the network node to communicate with a CU. The one or more processors may be configured to cause the network node to communicate with a set of one or more DUs. The one or more processors may be configured to cause the network node to receive, from the CU, an indication of a handover from a first cell associated with a first DU to a second cell associated with a second DU. The one or more processors may be configured to cause the network node to transmit, to the first DU, an indication of a UE context modification request associated with the first cell. The one or more processors may be configured to cause the network node to receive, from the first DU, an indication of a UE context modification response. The one or more processors may be configured to cause the network node to transmit, to the second DU, an indication of a UE context setup request associated with the second cell. The one or more processors may be configured to cause the network node to receive, from the second DU, an indication of a UE context setup response.

Some aspects described herein relate to a network node for wireless communication. The network node may include one or more memories and one or more processors coupled to the one or more memories. The one or more processors may be configured to cause the network node to communicate with a UE via a source DU. The one or more processors may be configured to cause the network node to receive an indication of signal measurements associated with triggering a handover from the source DU to a target DU. The one or more processors may be configured to cause the network node to transmit, to one of the source DU or the target DU, a request for coordination associated with the handover. The one or more processors may be configured to cause the network node to receive, from one of the source DU or the target DU, a response to the request for the coordination.

Some aspects described herein relate to a first DU for wireless communication. The first distributed unit may include one or more memories and one or more processors coupled to the one or more memories. The one or more processors may be configured to cause the first DU to receive, directly or indirectly from a CU, a request for coordination of a handover associated with a UE and a second DU. The one or more processors may be configured to cause the network node to communicate, with the second DU, handover coordination information.

Some aspects described herein relate to a non-transitory computer-readable medium that stores a set of instructions for wireless communication by a network node. The set of instructions, when executed by one or more processors of the network node, may cause the network node to establish a network interface link with a CU. The set of instructions, when executed by one or more processors of the network node, may cause the network node to establish a set of one or more network interface links with a set of one or more DUs. The set of instructions, when executed by one or more processors of the network node, may cause the network node to receive a first communication intended for a destination node via the network interface link. The set of instructions, when executed by one or more processors of the network node, may cause the network node to transmit the first communication to a first DU of the set of one or more DUs via a first network interface link of the set of one or more network interface links. The set of instructions, when executed by one or more processors of the network node, may cause the network node to receive a second communication intended for the destination node via the network interface link. The set of instructions, when executed by one or more processors of the network node, may cause the network node to transmit, after transmitting the first communication via the first network interface link, the second communication to a second DU via a second network interface link.

Some aspects described herein relate to a non-transitory computer-readable medium that stores a set of instructions for wireless communication by a network node. The set of instructions, when executed by one or more processors of the network node, may cause the network node to communicate with a CU. The set of instructions, when executed by one or more processors of the network node, may cause the network node to communicate with a set of one or more DUs. The set of instructions, when executed by one or more processors of the network node, may cause the network node to receive, from the CU, an indication of a handover from a first cell associated with a first DU to a second cell associated with a second DU. The set of instructions, when executed by one or more processors of the network node, may cause the network node to transmit, to the first DU, an indication of a UE context modification request associated with the first cell. The set of instructions, when executed by one or more processors of the network node, may cause the network node to receive, from the first DU, an indication of a UE context modification response. The set of instructions, when executed by one or more processors of the network node, may cause the network node to transmit, to the second DU, an indication of a UE context setup request associated with the second cell. The set of instructions, when executed by one or more processors of the network node, may cause the network node to receive, from the second DU, an indication of a UE context setup response.

Some aspects described herein relate to a non-transitory computer-readable medium that stores a set of instructions for wireless communication by a network node. The set of instructions, when executed by one or more processors of the network node, may cause the network node to communicate with a UE via a source DU. The set of instructions, when executed by one or more processors of the network node, may cause the network node to receive an indication of signal measurements associated with triggering a handover from the source DU to a target DU. The set of instructions, when executed by one or more processors of the network node, may cause the network node to transmit, to one of the source DU or the target DU, a request for coordination associated with the handover. The set of instructions, when executed by one or more processors of the network node, may cause the network node to receive, from one of the source DU or the target DU, a response to the request for the coordination.

Some aspects described herein relate to a non-transitory computer-readable medium that stores a set of instructions for wireless communication by a first DU. The set of instructions, when executed by one or more processors of the DU, may cause the DU to receive, directly or indirectly from a CU, a request for coordination of a handover associated with a UE and a second DU. The set of instructions, when executed by one or more processors of the DU, may cause the DU to communicate, with the second DU, handover coordination information.

Some aspects described herein relate to an apparatus for wireless communication. The apparatus may include means for establishing a network interface link with a CU. The apparatus may include means for establishing a set of one or more network interface links with a set of one or more DUs. The apparatus may include means for receiving a first communication intended for a destination node via the network interface link. The apparatus may include means for transmitting the first communication to a first DU of the set of one or more DUs via a first network interface link of the set of one or more network interface links. The apparatus may include means for receiving a second communication intended for the destination node via the network interface link. The apparatus may include means for transmitting, after transmitting the first communication via the first network interface link, the second communication to a second DU via a second network interface link.

Some aspects described herein relate to an apparatus for wireless communication. The apparatus may include means for communicating with a CU. The apparatus may include means for communicating with a set of one or more DUs. The apparatus may include means for receiving, from the CU, an indication of a handover from a first cell associated with a first DU to a second cell associated with a second DU. The apparatus may include means for transmitting, to the first DU, an indication of a UE context modification request associated with the first cell. The apparatus may include means for receiving, from the first DU, an indication of a UE context modification response. The apparatus may include means for transmitting, to the second DU, an indication of a UE context setup request associated with the second cell. The apparatus may include means for receiving, from the second DU, an indication of a UE context setup response.

Some aspects described herein relate to an apparatus for wireless communication. The apparatus may include means for communicating with a UE via a source DU. The apparatus may include means for receiving an indication of signal measurements associated with triggering a handover from the source DU to a target DU. The apparatus may include means for transmitting, to one of the source DU or the target DU, a request for coordination associated with the handover. The apparatus may include means for receiving, from one of the source DU or the target DU, a response to the request for the coordination.

Some aspects described herein relate to an apparatus for wireless communication. The apparatus may include means for receiving, directly or indirectly from a CU, a request for coordination of a handover associated with a UE and a DU. The apparatus may include means for communicating, with the DU, handover coordination information.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a regenerative satellite deployment and an example of a transparent satellite deployment in a non-terrestrial network.

FIG. 5 is a diagram illustrating an example of make-before-break handover, in accordance with the present disclosure.

FIG. 6 is a diagram of an example associated with using a non-terrestrial network (NTN) gateway for managing communications between a central unit (CU) and a set of distributed units (DUs), in accordance with the present disclosure.

FIG. 7 is a diagram illustrating an example of management of NTN-based F1 interfaces, in accordance with the present disclosure.

FIG. 8 is a diagram illustrating an example of management of NTN-based F1 interfaces, in accordance with the present disclosure.

FIG. 9 is a diagram illustrating an example process performed, for example, at a network node or an apparatus of a network node, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

FIG. 13 is a diagram illustrating an example of handovers, in accordance with the present disclosure.

FIGS. 14-17 are diagrams illustrating examples of handovers, in accordance with the present disclosure.

FIG. 18 is a diagram illustrating examples of UE context coordination requests, in accordance with the present disclosure.

FIG. 19 is a diagram illustrating an example process performed, for example, at a network node or an apparatus of a network node, in accordance with the present disclosure.

FIG. 20 is a diagram illustrating an example process performed, for example, at a DU or an apparatus of a DU, in accordance with the present disclosure.

FIG. 21 is a diagram of an example apparatus for wireless communication, in accordance with the present disclosure.

FIG. 22 is a diagram of an example apparatus for wireless communication, in accordance with the present disclosure.

### DETAILED DESCRIPTION

In some networks (e.g., a non-terrestrial network (NTN)), distributed units (DUs) may be connected to a central unit (CU) via an F1 interface. In some of these networks, the DUs may be mobile (e.g., satellite DUs). In this case, the CU may consume power, computing, network, and/or communication resources to release DUs that move out of range and to setup DUs that move into range of the CU. Similarly, a user equipment (UE) connected to the CU via a DU that is mobile may be handed over between DUs as the DUs move out of range and into range of the UE. The handover operation may consume power, computing, network, and/or communication resources of the CU to handover the UE from one DU to another DU.

Various aspects relate generally to using an NTN gateway for managing communications between a CU and a set of DUs. Some aspects more specifically relate to establishing a first network interface between the NTN gateway and the CU, where the NTN gateway and the CU are stationary relative to each other. The NTN gateway establishes and manages second network interfaces with the set of DUs while maintaining the network interface with the CU. In some aspects, the NTN gateway may manage handovers of connected UEs among the set of DUs. In this way, the CU may view the handovers as intra-DU handovers, which may reduce signaling between the CU and the DUs.

Particular aspects of the subject matter described in this disclosure can be implemented to realize one or more of the following potential advantages. In some examples, by having the gateway manage setup and release of DUs via the second network interfaces, a processing load associated with setup and releases of the DUs may be offloaded to the NTN gateway and the CU may conserve processing resources for managing network communications. Additionally, or alternatively, by having the NTN gateway manage handovers among the DUs, the CU may reduce signaling for the handover (e.g., based at least in part on seeing the handover as an intra-DU handover) and/or may conserve computing resources that may have otherwise been used to manage an inter-DU handover directly with the DUs.

In some networks, a CU may manage an inter-DU handover by transmitting a request, and receiving a response from, a source DU, then a target DU, and then the source DU again. This may cause a latency of the handover that negatively affects performance of a connected device that is handed over from the source DU to the target DU (e.g., a UE connected to the CU via the source DU). For example, each set of requests and responses may be associated with a feederlink delay and/or may increase a signaling load of a feederlink.

Various aspects relate generally to using DU coordination for managing an inter-DU handover. Some aspects more specifically relate to a network node (e.g., a CU or an NTN gateway) transmitting a DU coordination request to a first DU (e.g., either the source DU or the target DU) and receiving a response from a second DU, which may be the same as the first DU (e.g., the source DU or the target DU). In some aspects, the target DU and the source DU exchange coordination information before the second DU transmits the response to the network node.

Particular aspects of the subject matter described in this disclosure can be implemented to realize one or more of the following potential advantages. In some examples, by using DU coordination, a number of messages sent to or from the network node may be reduced, which may reduce network congestion and conserve power and/or computing resources of the network node.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

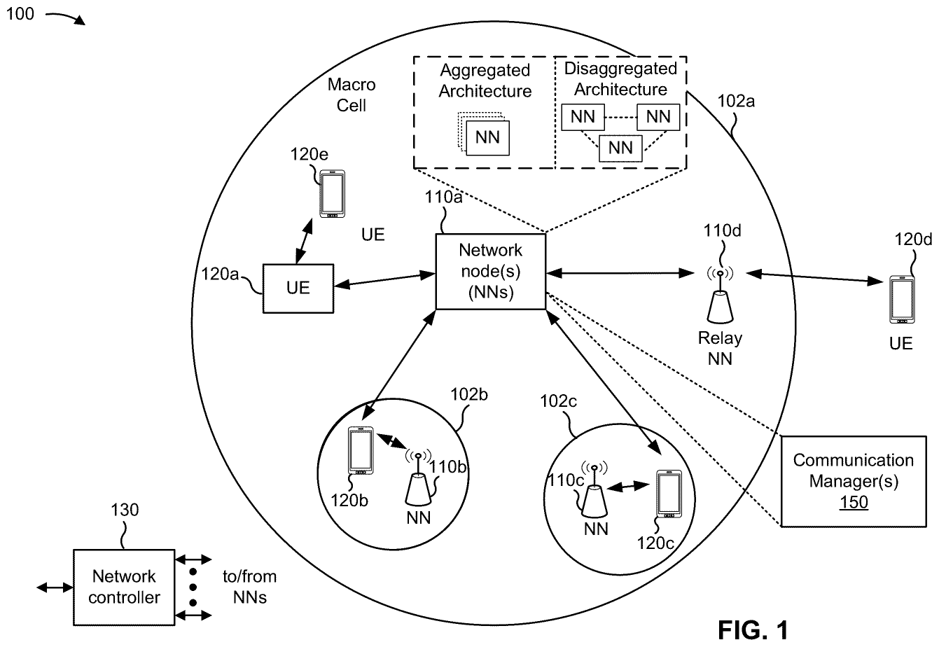

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more CUs, one or more DUs, or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the network node 110 may include a communication manager 150. As described in more detail elsewhere herein, the communication manager 150 may establish a network interface link with a CU; establish a set of one or more network interface links with a set of one or more DUs; receive a first communication intended for a destination node via the network interface link; transmit the first communication to a first DU of the set of one or more DUs via a first network interface link of the set of one or more network interface links; receive a second communication intended for the destination node via the network interface link; and transmit, after transmitting the first communication via the first network interface link, the second communication to a second DU via a second network interface link. In some aspects, the network node 110 may include a communication manager 150. As described in more detail elsewhere herein, the communication manager 150 may communicate with a CU; communicate with a set of one or more DUs; receive, from the CU, an indication of a handover from a first cell associated with a first DU to a second cell associated with a second DU; transmit, to the first DU, an indication of a UE context modification request associated with the first cell; receive, from the first DU, an indication of a UE context modification response; transmit, to the second DU, an indication of a UE context setup request associated with the second cell; and receive, from the second DU, an indication of a UE context setup response.

In some aspects, the network node 110 may include a communication manager 150. As described in more detail elsewhere herein, the communication manager 150 may communicate with a UE via a source DU; receive an indication of signal measurements associated with triggering a handover from the source DU to a target DU; transmit, to one of the source DU or the target DU, a request for coordination associated with the handover; and receive, from one of the source DU or the target DU, a response to the request for the coordination. Additionally, or alternatively, the communication manager 150 may perform one or more other operations described herein.

In some aspects, the first DU may include a communication manager 150. As described in more detail elsewhere herein, the communication manager 150 may receive, directly or indirectly from a CU, a request for coordination of a handover associated with a UE and a second DU; and communicate, with the second DU, handover coordination information.

Additionally, or alternatively, the communication manager 150 may perform one or more other operations described herein.

As indicated above, FIG. 1 is provided as an example. Other examples may differ from what is described with regard to FIG. 1.

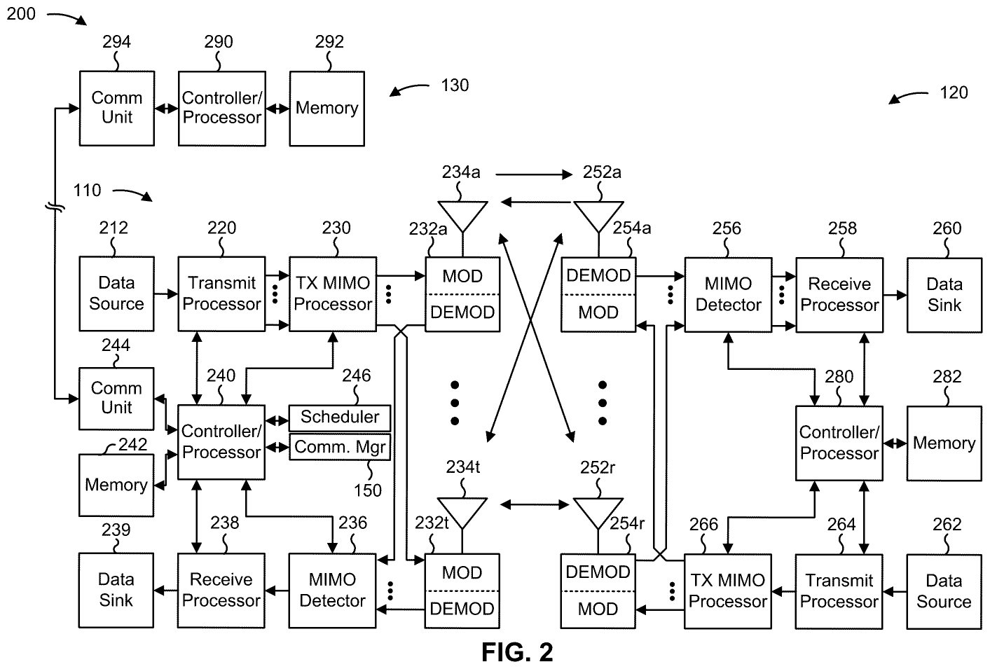

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

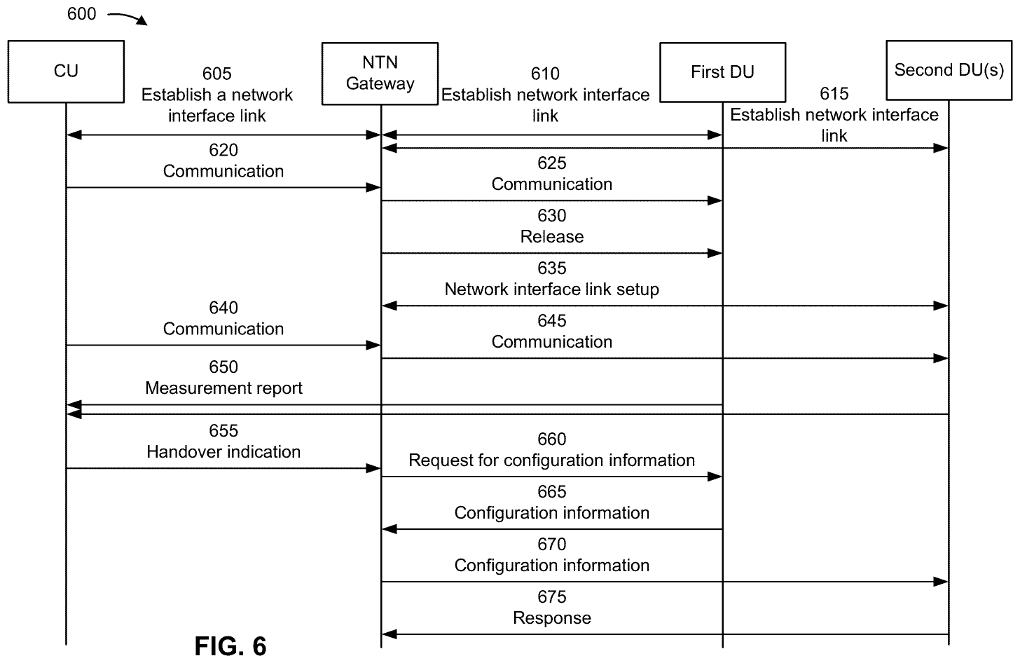

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-24).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-24).

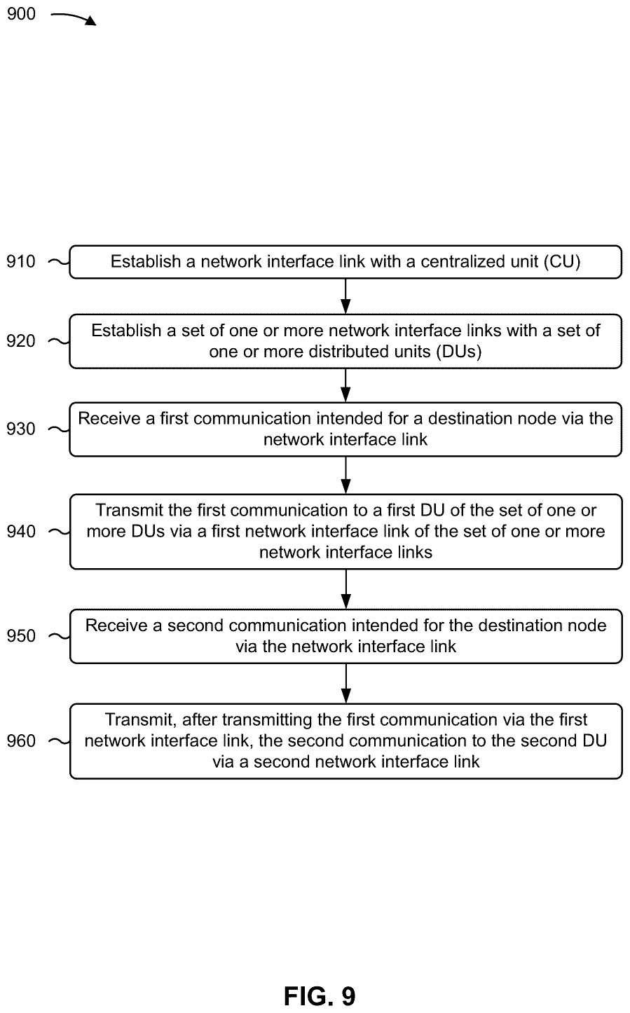

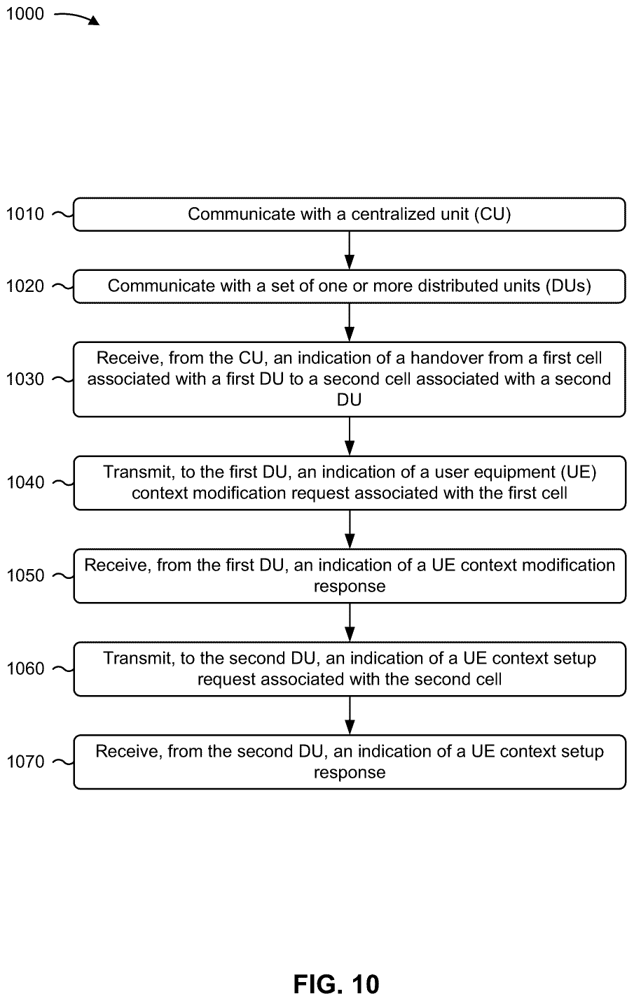

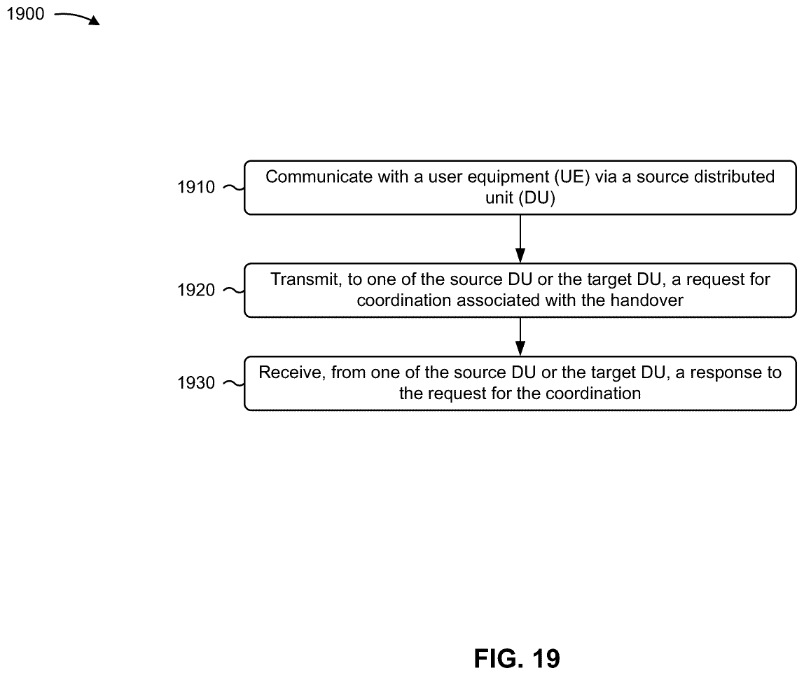

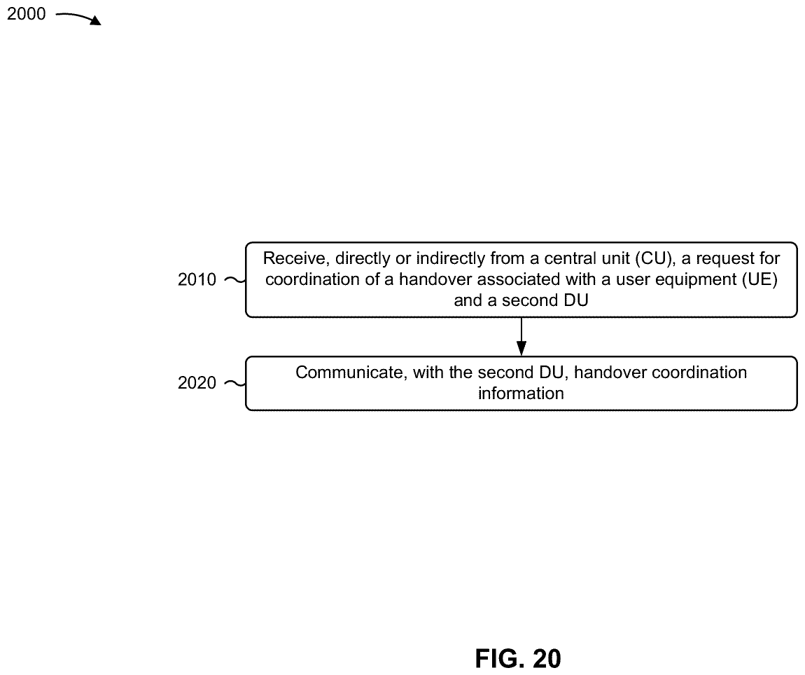

The controller/processor 240 of the network node 110, the controller/processor 280 of the UE 120, and/or any other component(s) of FIG. 2 may perform one or more techniques associated with using an NTN gateway for managing communications between a CU and a set of DUs and/or using DU coordination for managing an inter-DU handover, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, process 1900 of FIG. 19, process 2000 of FIG. 20, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, process 1900 of FIG. 19, process 2000 of FIG. 20, and/or other processes as described herein. In some examples, executing instructions may include running the instructions, converting the instructions, compiling the instructions, and/or interpreting the instructions, among other examples.

In some aspects, the network node includes means for establishing a network interface link with a CU; means for establishing a set of one or more network interface links with a set of one or more DUs; means for receiving a first communication intended for a destination node via the network interface link; means for transmitting the first communication to a first DU of the set of one or more DUs via a first network interface link of the set of one or more network interface links; means for receiving a second communication intended for the destination node via the network interface link; and/or means for transmitting, after transmitting the first communication via the first network interface link, the second communication to a second DU via a second network interface link.

In some aspects, the network node includes means for communicating with a CU; means for communicating with a set of one or more DUs; means for receiving, from the CU, an indication of a handover from a first cell associated with a first DU to a second cell associated with a second DU; means for transmitting, to the first DU, an indication of a UE context modification request associated with the first cell; means for receiving, from the first DU, an indication of a UE context modification response; means for transmitting, to the second DU, an indication of a UE context setup request associated with the second cell; and/or means for receiving, from the second DU, an indication of a UE context setup response.

In some aspects, the network node includes means for communicating with a UE via a source DU; means for receiving an indication of signal measurements associated with triggering a handover from the source DU to a target DU; means for transmitting, to one of the source DU or the target DU, a request for coordination associated with the handover; and/or means for receiving, from one of the source DU or the target DU, a response to the request for the coordination.

In some aspects, the first DU includes means for receiving, directly or indirectly from a CU, a request for coordination of a handover associated with a UE and a second DU; and/or means for communicating, with the second DU, handover coordination information.

In some aspects, the means for the first DU or for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

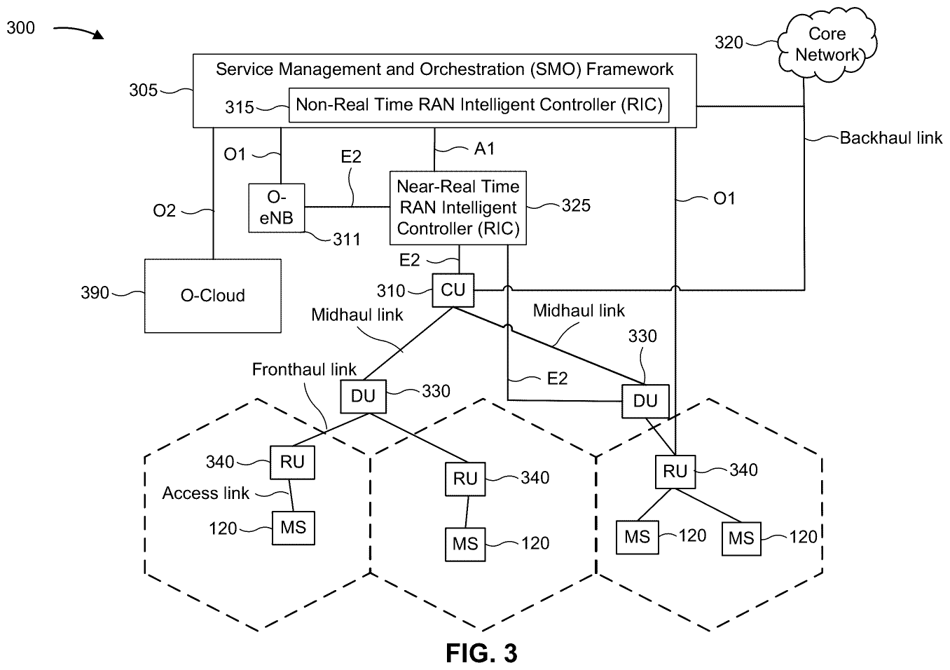

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

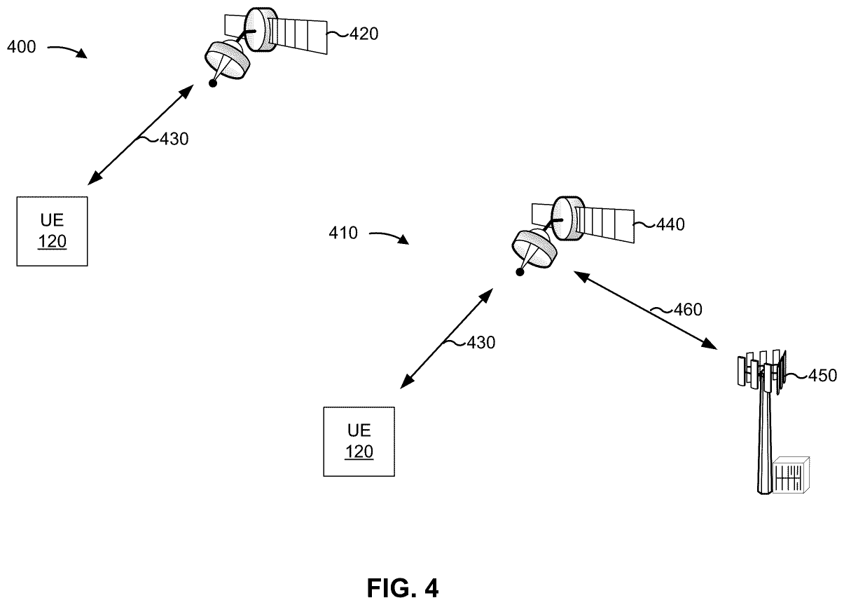

FIG. 4 is a diagram illustrating an example 400 of a regenerative satellite deployment and an example 410 of a transparent satellite deployment in a non-terrestrial network.

Example 400 shows a regenerative satellite deployment. In example 400, a UE 120 is served by a satellite 420 via a service link 430. For example, the satellite 420 may include a network node 110 (e.g., network node 110a) or a gNB. In some aspects, the satellite 420 may be referred to as a non-terrestrial base station, a regenerative repeater, or an on-board processing repeater. In some aspects, the satellite 420 may demodulate an uplink radio frequency signal, and may modulate a baseband signal derived from the uplink radio signal to produce a downlink radio frequency transmission. The satellite 420 may transmit the downlink radio frequency signal on the service link 430. The satellite 420 may provide a cell that covers the UE 120.

Example 410 shows a transparent satellite deployment, which may also be referred to as a bent-pipe satellite deployment. In example 410, a UE 120 is served by a satellite 440 via the service link 430. The satellite 440 may be a transparent satellite. The satellite 440 may relay a signal received from CU 450 via a feeder link 460. For example, the satellite may receive an uplink radio frequency transmission, and may transmit a downlink radio frequency transmission without demodulating the uplink radio frequency transmission. In some aspects, the satellite may frequency convert the uplink radio frequency transmission received on the service link 430 to a frequency of the uplink radio frequency transmission on the feeder link 460, and may amplify and/or filter the uplink radio frequency transmission. In some aspects, the UEs 120 shown in example 400 and example 410 may be associated with a Global Navigation Satellite System (GNSS) capability or a Global Positioning System (GPS) capability, though not all UEs have such capabilities. The satellite 440 may provide a cell that covers the UE 120.

The service link 430 may include a link between the satellite 440 and the UE 120, and may include one or more of an uplink or a downlink. The feeder link 460 may include a link between the satellite 440 and the CU 450, and may include one or more of an uplink (e.g., from the UE 120 to the gateway 450) or a downlink (e.g., from the CU 450 to the UE 120). An uplink of the service link 430 may be indicated by reference number 430-U (not shown in FIG. 4) and a downlink of the service link 430 may be indicated by reference number 430-D (not shown in FIG. 4). Similarly, an uplink of the feeder link 460 may be indicated by reference number 460-U (not shown in FIG. 4) and a downlink of the feeder link 460 may be indicated by reference number 460-D (not shown in FIG. 4).

The feeder link 460 and the service link 430 may each experience Doppler effects due to the movement of the satellites 420 and 440, and potentially movement of a UE 120. These Doppler effects may be significantly larger than in a terrestrial network. The Doppler effect on the feeder link 460 may be compensated for to some degree, but may still be associated with some amount of uncompensated frequency error. Furthermore, the CU 450 may be associated with a residual frequency error, and/or the satellite 420/440 may be associated with an on-board frequency error. These sources of frequency error may cause a received downlink frequency at the UE 120 to drift from a target downlink frequency.

In some aspects, the satellites 420 and 440 may operate as DUs linked to the CU 450. The DUs may provide a Uu link to a UE and may provide a link between the UE and the CU 450 via an F1 interface between the DUs and the CU 450.

As indicated above, FIG. 4 is provided as an example. Other examples may differ from what is described with regard to FIG. 4.

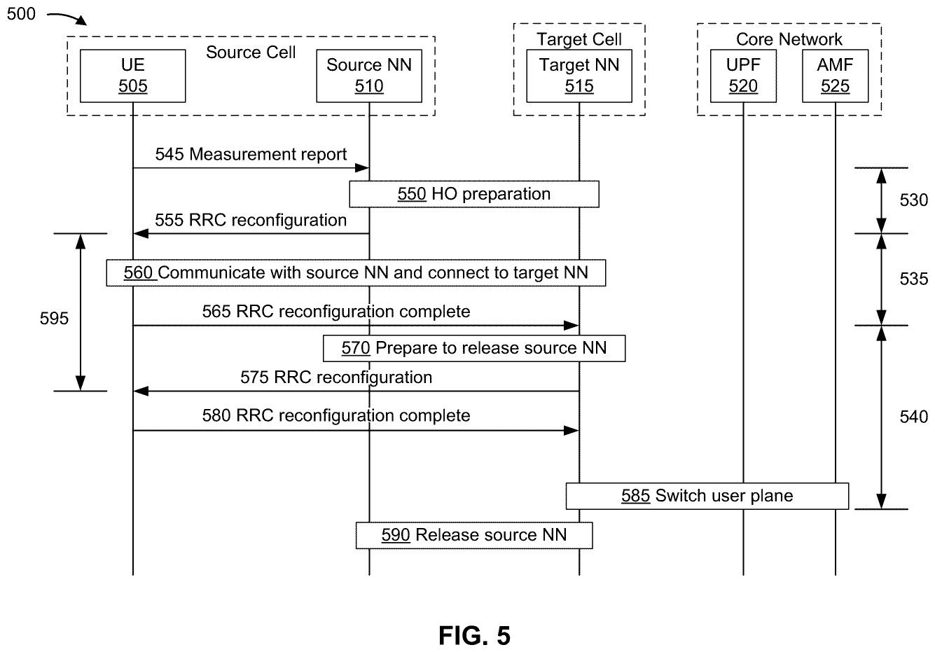

FIG. 5 is a diagram illustrating an example 500 of make-before-break handover, in accordance with the present disclosure.

As shown in FIG. 5, a make-before-break (MBB) handover procedure may involve a UE 505, a source network node 510, a target network node 515, a user plane function (UPF) device 520, and an access and mobility management function (AMF) device 525. In some examples, actions described as being performed by a network node may be performed by multiple different network nodes. For example, configuration actions and/or core network communication actions may be performed by a first network node (e.g., a CU or a DU), and radio communication actions may be performed by a second network node (e.g., a DU or an RU). The UE 505 may correspond to the UE 120 described elsewhere herein. The source network node 510 and/or the target network node 515 may correspond to the network node 110 described elsewhere herein. The UPF device 520 and/or the AMF device 525 may correspond to the network controller 130 described elsewhere herein. The UE 505 and the source network node 510 may be connected (e.g., may have an RRC connection) via a serving cell or a source cell, and the UE 505 may undergo a handover to the target network node 515 via a target cell. The UPF device 520 and/or the AMF device 525 may be located within a core network. The source network node 510 and the target network node 515 may be in communication with the core network for mobility support and user plane functions. The MBB handover procedure may include an enhanced MBB (eMBB) handover procedure.

As shown, the MBB handover procedure may include a handover preparation phase 530, a handover execution phase 535, and a handover completion phase 540. During the handover preparation phase 530, the UE 505 may report measurements that cause the source network node 510 and/or the target network node 515 to prepare for handover and trigger execution of the handover. During the handover execution phase 535, the UE 505 may execute the handover by performing a random access procedure with the target network node 515 and establishing an RRC connection with the target network node 515. During the handover completion phase 540, the source network node 510 may forward stored communications associated with the UE 505 to the target network node 515, and the UE 505 may be released from a connection with the source network node 510.

As shown by reference number 545, the UE 505 may perform one or more measurements, and may transmit a measurement report to the source network node 510 based at least in part on performing the one or more measurements (e.g., serving cell measurements and/or neighbor cell measurements). The measurement report may indicate, for example, an RSRP parameter, an RSRQ parameter, an RSSI parameter, and/or a signal-to-interference-plus-noise-ratio (SINR) parameter (e.g., for the serving cell and/or one or more neighbor cells). The source network node 510 may use the measurement report to determine whether to trigger a handover to the target network node 515. For example, if one or more measurements satisfy a condition, then the source network node 510 may trigger a handover of the UE 505 to the target network node 515.

As shown by reference number 550, the source network node 510 and the target network node 515 may communicate with one another to prepare for a handover of the UE 505. As part of the handover preparation, the source network node 510 may transmit a handover request to the target network node 515 to instruct the target network node 515 to prepare for the handover. The source network node 510 may communicate RRC context information associated with the UE 505 and/or configuration information associated with the UE 505 to the target network node 515. The target network node 515 may prepare for the handover by reserving resources for the UE 505. After reserving the resources, the target network node 515 may transmit an acknowledgement (ACK) to the source network node 510 in response to the handover request.

As shown by reference number 555, the source network node 510 may transmit an RRC reconfiguration message to the UE 505. The RRC reconfiguration message may include a handover command instructing the UE 505 to execute a handover procedure from the source network node 510 to the target network node 515. The handover command may include information associated with the target network node 515, such as a random access channel (RACH) preamble assignment for accessing the target network node 515. Reception of the RRC reconfiguration message, including the handover command, by the UE 505 may trigger the start of the handover execution phase 535.

As shown by reference number 560, during the handover execution phase 535 of the MBB handover, the UE 505 may execute the handover by performing a random access procedure with the target network node 515 (e.g., including synchronization with the target network node 515) while continuing to communicate with the source network node 510. For example, while the UE 505 is performing the random access procedure with the target network node 515, the UE 505 may transmit uplink data, uplink control information, and/or an uplink reference signal (e.g., a sounding reference signal) to the source network node 510, and/or may receive downlink data, downlink control information, and/or a downlink reference signal from the source network node 510.

As shown by reference number 565, upon successfully establishing a connection with the target network node 515 (e.g., via a random access procedure), the UE may transmit an RRC reconfiguration completion message to the target network node 515. Reception of the RRC reconfiguration message by the target network node 515 may trigger the start of the handover completion phase 540.

As shown by reference number 570, the source network node 510 and the target network node 515 may communicate with one another to prepare for release of the connection between the source network node 510 and the UE 505. In some aspects, the target network node 515 may determine that a connection between the source network node 510 and the UE 505 is to be released, such as after receiving the RRC reconfiguration message from the UE 505. In this case, the target network node 515 may transmit a handover connection setup completion message to the source network node 510. The handover connection setup completion message may cause the source network node 510 to stop transmitting data to the UE 505 and/or to stop receiving data from the UE 505. Additionally, or alternatively, the handover connection setup completion message may cause the source network node 510 to forward communications associated with the UE 505 to the target network node 515 and/or to notify the target network node 515 of a status of one or more communications with the UE 505. For example, the source network node 510 may forward, to the target network node 515, buffered downlink communications (e.g., downlink data) for the UE 505 and/or uplink communications (e.g., uplink data) received from the UE 505. Additionally, or alternatively, the source network node 510 may notify the target network node 515 regarding a PDCP status associated with the UE 505 and/or a sequence number to be used for a downlink communication with the UE 505.

As shown by reference number 575, the target network node 515 may transmit an RRC reconfiguration message to the UE 505 to instruct the UE 505 to release the connection with the source network node 510. Upon receiving the instruction to release the connection with the source network node 510, the UE 505 may stop communicating with the source network node 510. For example, the UE 505 may refrain from transmitting uplink communications to the source network node 510 and/or may refrain from monitoring for downlink communications from the source network node 510.

As shown by reference number 580, the UE may transmit an RRC reconfiguration completion message to the target network node 515 to indicate that the connection between the source network node 510 and the UE 505 is being released or has been released.

As shown by reference number 585, the target network node 515, the UPF device 520, and/or the AMF device 525 may communicate to switch a user plane path of the UE 505 from the source network node 510 to the target network node 515. Prior to switching the user plane path, downlink communications for the UE 505 may be routed through the core network to the source network node 510. After the user plane path is switched, downlink communications for the UE 505 may be routed through the core network to the target network node 515. Upon completing the switch of the user plane path, the AMF device 525 may transmit an end marker message to the source network node 510 to signal completion of the user plane path switch. As shown by reference number 590, the target network node 515 and the source network node 510 may communicate to release the source network node 510.

As part of the MBB handover procedure, the UE 505 may maintain simultaneous connections with the source network node 510 and the target network node 515 during a time period 595. The time period 595 may start at the beginning of the handover execution phase 535 (e.g., upon reception by the UE 505 of a handover command from the source network node 510) when the UE 505 performs a random access procedure with the target network node 515. The time period 595 may end upon release of the connection between the UE 505 and the source network node 510 (e.g., upon reception by the UE 505 of an instruction, from the target network node 515, to release the source network node 510). By maintaining simultaneous connections with the source network node 510 and the target network node 515, the handover procedure can be performed with zero or a minimal interruption to communications, thereby reducing latency.

In context of an NTN network, the source network node (NN) 510 and the target NN 515 may be NTN DUs (e.g., satellite DUs or other aerial DUs). The core network may include a CU that manages the source NN 510 and the target NN 515 and/or additional network nodes.

As indicated above, FIG. 5 is provided as an example. Other examples may differ from what is described with respect to FIG. 5.

In the case of an Earth moving cell (EMC) with a gNB-DU (DU) processed payload, a DU and a gNB-CU (e.g., a CU that is ground-based) may establish and release F1 interfaces frequently according to movement of the EMC DU. This may cause the CU to consume processing and power resources.

In some aspects described herein, network may include an NTN gateway between the DU and the CU, such that a processing load associated with F1-setup and release may be offloaded to the NTN gateway. In some aspects, the CU may be associated with multiple NTN gateways.

In some aspects, the NTN gateway may act as a proxy CU end point towards DUs (e.g., satellite DUs). Similarly, the NTN gateway may act as a proxy DU end point towards the CU. The NTN gateway may perform F1-AP and F1-U routing between the CU and the DUs.

In some aspects of using the NTN gateway to manage the DUs, a user plan entity of the DU may communicate with a user plane entity of the NTN gateway via a first F1 interface. In a second F1 interface between the NTN gateway and the CU, the NTN gateway and the CU may communicate via a GTP-U layer and via a user datagram protocol (UDP) layer (e.g., instead of the DU communicating with the CU via the general packet radio service (GPRS) tunnelling protocol (GTP)-U layer and via a UDP layer, with the NTN gateway routing between the CU and the DU). In some aspects, the NTN gateway may communication with the DU via the first F1 interface, including via an F1 application layer. The NTN gateway may also communicate with the CU via an F1-AP and a stream control transmission protocol (SCTP) layer (e.g., instead of the DU communicating with the CU via the F1-AP and an SCTP layer, with the NTN gateway routing between the CU and the DU).

In some networks, that use EMCs, multiple UEs (e.g., connected to the CU via a DU that is moving out of coverage of the multiple UEs) may perform inter-DU handovers simultaneously (e.g., within a threshold amount of time). Based at least in part on the handovers, the CU may exchange several messages with a source-DU and a target DU to perform the handovers. For example, the CU may exchange context a UE context modification request/response with the source DU, a UE context setup request/response with the target DU, and another UE context modification request/response with the source DU. After these exchanges, the CU may exchange a UE context release command/completion message with the source DU. This may cause the CU to consume processing and power resources and may cause latency in the handover.

In some aspects, an NTN gateway may perform preparation procedures with DUs instead of a CU performing the preparation procedures for inter-DU handovers. From a perspective of the CU, the NTN gateway (e.g., connected to DUs) may be considered as “single DU.” In this way, the CU may trigger an intra-DU handover to the NTN gateway even for inter-cell handovers across different DUs. Upon a trigger from the CU, the NTN gateway may exchange messages with a source-DU (e.g., for a latest configuration enquiry) and a target DU (e.g., for UE context setup). This may be realized by utilizing a part of existing DU preparation procedures for an inter-DU HO.

In an example of a handover procedure using an NTN gateway to combine an intra-DU handover and an inter-DU handover procedure, the NTN gateway may communicate as an intermediary between the DUs and the CU. For example, the NTN gateway may be configured with mapping info between cells and DUs. From a perspective of the CU, the NTN gateway is seen as a single DU. A UE may send a measurement report to a source DU, which may send the measurement report to the NTN gateway. The NTN gateway may send the measurement report to the CU.

The CU may send a UE context modification request to the NTN gateway to trigger a handover. The NTN gateway may send the UE context modification request to the source DU to request to obtain a latest configuration. The source DU may respond with a UE context modification response. The NTN gateway may send a UE context setup request to a target DU. The target DU may respond with a UE context setup response to the NTN gateway. The NTN gateway may send a UE context modification request to the source DU (e.g., with an RRC reconfiguration message to be sent to the UE). The source DU may send the RRC reconfiguration message to the UE to indicate that the handover is to occur.

The source DU may send a UE context modification response to the NTN gateway (e.g., in response to receiving the UE context modification request). The NTN gateway may send the UE context modification response to the CDU (response to step 2a). The UE may perform a random access (RA) procedure towards the target DU to establish a new connection. The UE may send an RRC reconfiguration complete message to the target DU, which may send the RRC reconfiguration complete message to the NTN gateway, and then along to the CU. The NTN gateway may then send a UE context release command to the source DU, and the source DU may respond with a UE context release complete message.

This technique may simply communications and management burdens of the CU, as the CU only communications with the NTN gateway for the handovers. In this way, the CU may offload required processing and power resource consumption to the NTN gateway.

In some networks, when an inter-DU handover is performed (e.g., with or without an NTN gateway), 3 rounds of requests-responses are performed. First, an exchange between a source DU and a network node (e.g., the CU or the NTN gateway). Second, an exchange between a target DU and the network node (e.g., the CU or the NTN gateway). Third, an exchange between the source DU and the network node (CU or NTN-GW). Each round of exchanges may cause delay (e.g., latency) associated with a feederlink delay. Additionally, or alternatively, each round of exchange may increase a signaling load of the feederlink.

In some aspects described herein, a source DU and a target DU may exchange messages directly to reduce message exchanges between a network node (e.g., a CU or an NTN gateway) and one or more DUs. In some aspects, the network node may send a request message to only one DU, of the source DU and the target DU. The DU that receives the request message may coordinate with a peer DU (e.g., the other DU involved in the handover). The CU may receive a response message from only one of the DUs, which may be the DU that received the request or the other DU involved in the handover. In some aspects, the DU that receives the request message may be either the source DU or the target DU, and the DU that transmits the response message may be either the source DU or the target DU. For example the CU may communicate these messages with only one DU or may communicate a first of these messages with a first DU and a second of these messages with a second DU. In some aspects, the DU or DUs with which the CU communicates may be selected based at least in part on a feederlink availability (e.g., based on a state of the DU and/or a state of an interface indicating whether the feederlink is available or unavailable).

When the network node receives the response message, the network node (e.g., the CU) may proceed with further rounds of the handover (e.g., a UE context modification, a UE RRC reconfiguration, and/or a UE context release).

In NTNs, an inter-satellite link (ISL) may be used for inter-DU coordination. In some aspects, an ISL may have higher performance than that of a feederlink (e.g., optical link).

In some aspects, the request message may include a UE context modification request, a UE context setup request, UE con context setup information, and/or UE context modification information. For example, the CU may transmit a concatenation of the UE context modification request (for the source DU) and the UE context setup request (for the target DU). In some aspects, the CU may transmit the UE context modification request and the UE context setup request in separate messages, with each message including an indication of a link between the messages (e.g., linkage information, such as a same transaction ID). In some aspects, the CU may transmit a UE context modification request that includes UE context setup information. In some aspects, the CU may transmit a UE context setup request that includes UE context modification information.

FIG. 6 is a diagram of an example 600 associated with using an NTN gateway for managing communications between a CU and a set of DUs, in accordance with the present disclosure. As shown in FIG. 6, a CU may communicate with an NTN gateway (e.g., via an F1 interface). The NTN gateway may communicate with a first DU and one or more second DUs via second F1 interfaces. In some aspects, the NTN gateway may provide a connection between the CU and the first DU and between the CU and the one or more second DUs. In some aspects, the CU, the NTN gateway (e.g., NTN gateway node), the first DU, and the one or more second DUs may be part of a wireless network (e.g., wireless network 100). In some aspects, the first DU and/or the one or more second DUs may include an NTN DU, such as a satellite-based DU or other aerial DU.

As shown by reference number 605, the CU and the NTN gateway may establish a network interface link (e.g., an F1 interface link). For example, the CU and the NTN gateway may exchange configuration information and/or capability information. In some aspects, the CU may provide a configuration for mapping the CU to the one or more DUs.

As shown by reference number 610, the NTN gateway may establish a network interface link with the first DU. As further shown by reference number 615, the NTN gateway may establish network interface links with the one or more second DUs. In some aspects, each of the network interface links may be F1 interface links.

As shown by reference number 620, the CU may transmit, and the NTN gateway may receive, a communication. In some aspects, the CU may transmit the communication via an OTA communication or via a cable connection (e.g., a fiberoptic link). In some aspects, the communication may be intended for a destination node, such as a UE. The UE may be reachable via the NTN gateway and the first DU.

As shown by reference number 625, the NTN way may transmit the communication to the first DU. The first DU may forward the communication toward an intended destination node.

As shown by reference number 630, the NTN gateway may release the first DU. In some aspects, the NTN gateway may release the first DU based at least in part on mobility or availability of the first DU and/or availability of the network interface link with the first DU (e.g., based on a state of the first DU and/or a state of the network interface link with the first DU, which may indicate whether the first DU and/or the network interface link with the first DU is available or unavailable). For example, the first DU may move out of range of the NTN gateway or out of range of the intended destination node, which may result in the first DU and/or the network interface link with the first DU becoming unavailable. In some aspects, releasing the network interface link with the first DU may be independent from the network interface link between the CU and the NTN gateway. For example, the NTN gateway and the CU may not need to reestablish a connection after releasing the first DU.

As shown by reference number 635, the NTN gateway and a DU of the one or more second DUs may perform a network interface link setup. In some aspects, the NTN gateway and/or the DU may initiate the network interface link setup based at least in part on releasing the first DU and/or movement of the DU (e.g., into a coverage area of the NTN gateway and/or the UE). In some aspects, the NTN gateway may establish a network interface link with the DU after communicating with the first DU. In some aspects, the network interface link setup associated with the DU may be independent from the network interface link between the NTN gateway and the CU.

In some aspects, the NTN gateway may establish, release, suspend, or resume connections with DUs based at least in part on a connection availability between the network node the one or more DUs (e.g., based at least in part on state information that indicates whether the connection(s) between the network node and the one or more DUs are available or unavailable). In some aspects, the connection availability or state information may be based at least in part on movements of the one or more DUs. For example, the NTN gateway may maintain a list of active DUs that are currently in range and/or a list of inactive DUs that are currently out of range (e.g., that are saved for potential resuming at a future time).

As shown by reference number 640, the CU may transmit, and the NTN gateway may receive, a communication (e.g., a second communication) to the DU of the one or more DUs. In some aspects, the second communication may be intended for the same destination node as the communication described in connection with reference number 620.

As shown by reference number 645, the NTN gateway may transmit, and the DU of the one or more second DUs may receive, the communication. In some aspects, the NTN gateway may transmit the communication to the DU based at least in part on the DU moving into coverage of the NTN gateway and/or the destination node. For example, the NTN gateway may transmit the second communication to the destination node via the second network interface link based at least in part on one or more of movement of the first DU and/or movement of a second DU associated with the second network interface link.

As shown by reference number 650, the CU may receive a measurement report from the first DU or a DU of the one or more second DUs. In some aspects, the measurement report may indicate that a handover may improve a communication link between the CU and a destination node.

As shown by reference number 655, the CU may transmit a handover indication to the NTN gateway. For example, the CU may transmit an indication of an intra-DU handover from the first DU the DU of the one or more second DUs. In some aspects, the NTN gateway may initiate an inter-DU handover from the first DU to the DU.

As shown by reference number 660, the NTN gateway may transmit, and the first DU may receive, a request for configuration information. The request for configuration information may include an indication of a UE context modification request associated with the first cell of the first DU.

In some aspects, the configuration information may include first configuration information associated with a first link between the first DU and a destination node. For example, the configuration information may include information associated with a current or most recent configuration for communicating with a destination node.

As shown by reference number 665, the NTN gateway may receive, and the first DU may transmit, the configuration information. In some aspects, the configuration information from the first DU may include a UE context modification response.

As shown by reference number 670, the NTN gateway may transmit, and the DU of the one or more second DUs may receive, the configuration information. In some aspects, the configuration information transmitted to the DU may include an indication of a UE context setup request associated with a second cell associated with the DU.

In some aspects, the NTN gateway may transmit second configuration information that is based at least in part on the first configuration information. The second configuration information may be associated with establishing a second link between the second DU and the destination node.

As shown by reference number 675, the NTN may receive, and the DU of the one or more second DUs may transmit, a response to the configuration information. In some aspects, the response to the configuration information may include an indication of a UE context setup response.

Based at least in part on having the gateway manage setup and release of DUs via the second network interfaces, a processing load associated with setup and releases of the DUs may be offloaded to the NTN gateway and the CU may conserve processing resources for managing network communications. Additionally, or alternatively, by having the NTN gateway manage handovers among the DUs, the CU may reduce signaling for the handover (e.g., based at least in part on seeing the handover as an intra-DU handover) and/or may conserve computing resources that may have otherwise been used to manage an inter-DU handover directly with the DUs.

As indicated above, FIG. 6 is provided as an example. Other examples may differ from what is described with respect to FIG. 6.

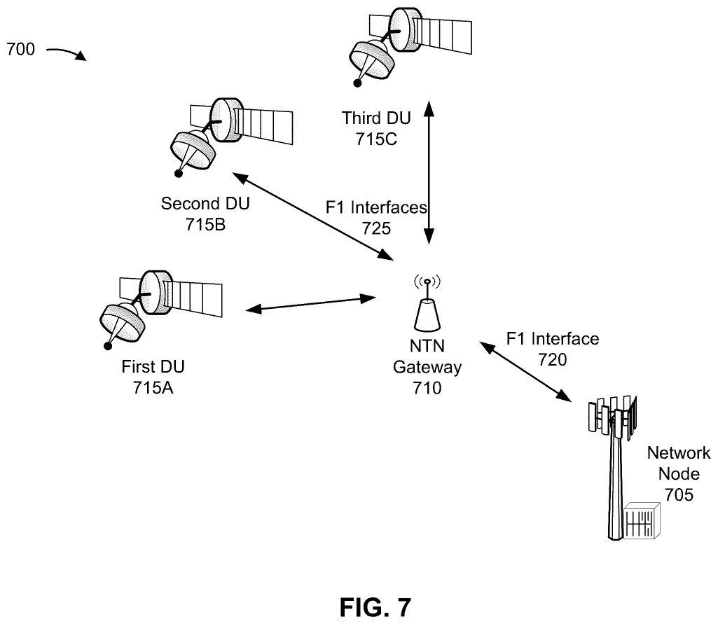

FIG. 7 is a diagram illustrating an example 700 of management of NTN-based F1 interfaces, in accordance with the present disclosure. As shown in FIG. 7, a network node 705 (e.g., a CU) may communicate with an NTN gateway 710 and one or more DUs 715A-715C.

The NTN gateway 710 may communicate with the network node 705 via an F1 interface 720. The NTN gateway 710 may manage communications with the DUs 715A-715C via F1 interfaces 725. In some aspects, the NTN gateway 710 may manage the F1 interfaces 725 without disruption of the F1 interface 720. For example the NTN gateway 710 may terminate or suspend an F1 interface 725 with a second DU 715B without disrupting the F1 interface 720. In this way, the network node may conserve processing and power resources that may have otherwise been consumed by actively adding and removing F1 interface links with the DUs 715A-715C (e.g., associated with movement of the DUs 715A-715C).

As indicated above, FIG. 7 is provided as an example. Other examples may differ from what is described with respect to FIG. 7.

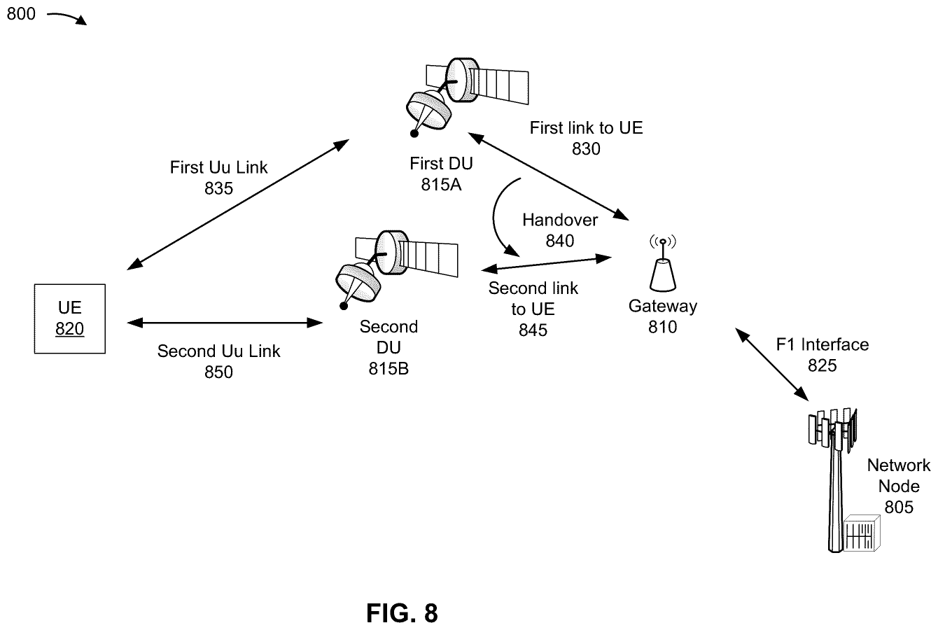

FIG. 8 is a diagram illustrating an example 800 of management of NTN-based F1 interfaces, in accordance with the present disclosure. As shown in FIG. 8, a network node 805 (e.g., a CU) may communicate with an NTN gateway 810 and a first DU 815A or a second DU 815B. The network node 805 may communicate with a UE 820 (e.g., a destination node) via the first DU 815A or the second DU 815B.

The NTN gateway 810 may communicate with the network node 805 via an F1 interface 825. The network node 805 may communicate with the UE 820 via the NTN gateway 810 and the first DU 815A via a first link to the UE 830 and a first Uu link 835. In some aspects, the UE 820 may transmit a measurement report that indicates that a handover may improve communications between the UE 820 and the network node 805. The network node 805 may transmit to the NTN gateway 810 an indication to perform the handover. In some aspects, the network node 805 may indicate to perform an intra-DU handover based at least in part on the presence of the NTN gateway (e.g., with the NTN gateway acting as a single DU to the network node 805).

The NTN gateway may perform a handover 840 to move the UE 820 from the first DU 815A to the second DU 815B. In some aspects, the network node 805 may be unaware of the inter-DU handover or may know without affecting the F1 interface 825.

As part of the handover 840, the second DU 815B may establish a second Uu link 850 with the UE 820 in place of the first Uu link 835. In some aspects, the NTN gateway 810 may establish a second link to the UE 845. The network node 805 may continue to communicate with the UE 820 via the NTN gateway 810, but using the second DU 815B instead of the first DU 815A. In this way, the network node 805 may not need to establish, release, or otherwise manage links with DUs.

As indicated above, FIG. 8 is provided as an example. Other examples may differ from what is described with respect to FIG. 8.

FIG. 9 is a diagram illustrating an example process 900 performed, for example, at a network node or an apparatus of a network node, in accordance with the present disclosure. Example process 900 is an example where the apparatus or the network node (e.g., network node 110 and/or an NTN gateway) performs operations associated with management of NTN-based F1 interfaces.

As shown in FIG. 9, in some aspects, process 900 may include establishing a network interface link with a CU (block 910). For example, the network node (e.g., using communication manager 1108, depicted in FIG. 9) may establish a network interface link with a CU, as described above.

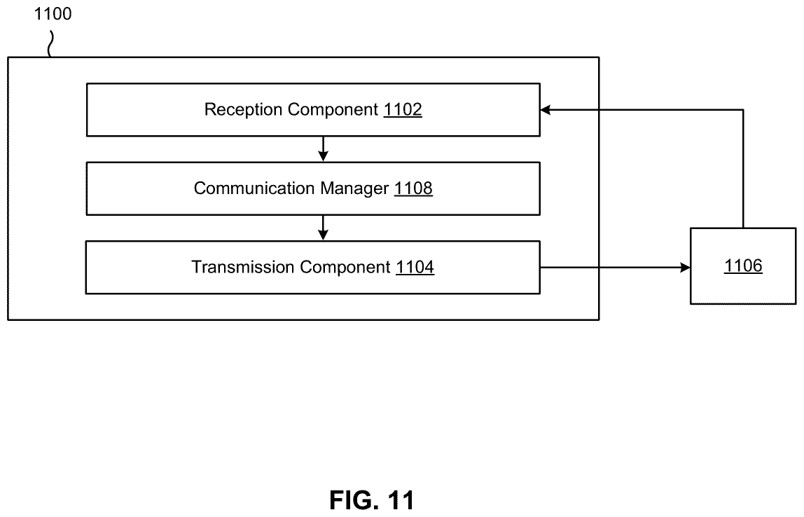

As further shown in FIG. 9, in some aspects, process 900 may include establishing a set of one or more network interface links with a set of one or more DUs (block 920). For example, the network node (e.g., using communication manager 1108, depicted in FIG. 11) may establish a set of one or more network interface links with a set of one or more DUs, as described above.

As further shown in FIG. 9, in some aspects, process 900 may include receiving a first communication intended for a destination node via the network interface link (block 930). For example, the network node (e.g., using reception component 1102 and/or communication manager 1108, depicted in FIG. 11) may receive a first communication intended for a destination node via the network interface link, as described above.

As further shown in FIG. 9, in some aspects, process 900 may include transmitting the first communication to a first DU of the set of one or more DUs via a first network interface link of the set of one or more network interface links (block 940). For example, the network node (e.g., using transmission component 1104 and/or communication manager 1108, depicted in FIG. 11) may transmit the first communication to a first DU of the set of one or more DUs via a first network interface link of the set of one or more network interface links, as described above.

As further shown in FIG. 9, in some aspects, process 900 may include receiving a second communication intended for the destination node via the network interface link (block 950). For example, the network node (e.g., using reception component 1102 and/or communication manager 1108, depicted in FIG. 11) may receive a second communication intended for the destination node via the network interface link, as described above.

As further shown in FIG. 9, in some aspects, process 900 may include transmitting, after transmitting the first communication via the first network interface link, the second communication to the end node via a second network interface link (block 960). For example, the network node (e.g., using transmission component 1104 and/or communication manager 1108, depicted in FIG. 9) may transmit, after transmitting the first communication via the first network interface link, the second communication to the end node via a second network interface link, as described above.

Process 900 may include additional aspects, such as any single aspect or any combination of aspects described below and/or in connection with one or more other processes described elsewhere herein.

In a first aspect, the set of one or more network interface links comprises the second network interface link, or wherein the network node establishes the second network interface link after establishing the set of one or more network interface links.

In a second aspect, alone or in combination with the first aspect, transmitting the second communication to the second DU via the second network interface link comprises transmitting the second communication to the second DU via the second network interface link based at least in part on one or more of movement or availability of the first DU associated with the first network interface link, availability of the first network interface link, movement or availability of the second DU associated with the second network interface link, or availability of the second network interface link.

In a third aspect, alone or in combination with one or more of the first and second aspects, process 900 includes releasing, suspending, or resuming the first network interface link after transmitting the first communication, wherein releasing, suspending, or resuming the first network interface link is based at least in part on a connection availability between the network node and the first DU and is independent from the network interface link with the CU.

In a fourth aspect, alone or in combination with one or more of the first through third aspects, process 900 includes performing a network interface link setup associated with the second network interface link before transmitting the second communication, wherein the network interface link setup associated with the second network interface link is independent from the network interface link with the CU.

In a fifth aspect, alone or in combination with one or more of the first through fourth aspects, process 900 includes receiving, from the CU, an indication of an intra-DU handover from the first DU associated with the first network interface link to the second DU associated with the second network interface link, and performing an inter-DU handover from the first DU to the second DU.

In a sixth aspect, alone or in combination with one or more of the first through fifth aspects, performing the inter-DU handover from the first DU to the second DU comprises receiving, from the first DU, first configuration information associated with a first link between the first DU and the destination node, and transmitting, to the second DU, second configuration information, based at least in part on the first configuration information, associated with establishing a second link between the second DU and the destination node.

In a seventh aspect, alone or in combination with one or more of the first through sixth aspects, the network node comprises a gateway node.

In an eighth aspect, alone or in combination with one or more of the first through seventh aspects, the set of one or more DUs comprises a set of one or more NTN DUs.

In a ninth aspect, alone or in combination with one or more of the first through eighth aspects, the network interface link and the one or more network interface links comprise F1 interface links.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110 and/or an NTN gateway) performs operations associated with management of NTN-based F1 interfaces.

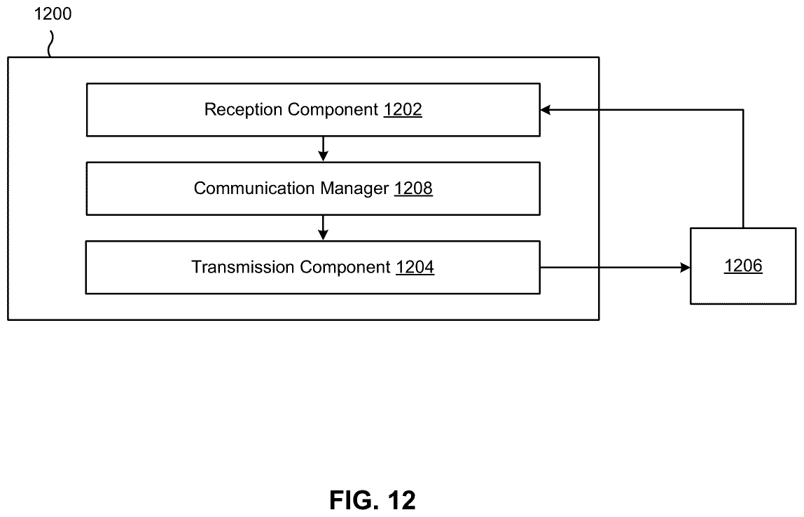

As shown in FIG. 10, in some aspects, process 1000 may include communicating with a CU (block 1010). For example, the network node (e.g., using reception component 1202, transmission component 1204, and/or communication manager 1208, depicted in FIG. 12) may communicate with a CU, as described above.

As further shown in FIG. 10, in some aspects, process 1000 may include communicating with a set of one or more DUs (block 1020). For example, the network node (e.g., using reception component 1202, transmission component 1204, and/or communication manager 1208, depicted in FIG. 12) may communicate with a set of one or more DUs, as described above.

As further shown in FIG. 10, in some aspects, process 1000 may include receiving, from the CU, an indication of a handover from a first cell associated with a first DU to a second cell associated with a second DU (block 1030). For example, the network node (e.g., using reception component 1202 and/or communication manager 1208, depicted in FIG. 12) may receive, from the CU, an indication of a handover from a first cell associated with a first DU to a second cell associated with a second DU, as described above.

As further shown in FIG. 10, in some aspects, process 1000 may include transmitting, to the first DU, an indication of a UE context modification request associated with the first cell (block 1040). For example, the network node (e.g., using transmission component 1204 and/or communication manager 1208, depicted in FIG. 12) may transmit, to the first DU, an indication of a UE context modification request associated with the first cell, as described above.

As further shown in FIG. 10, in some aspects, process 1000 may include receiving, from the first DU, an indication of a UE context modification response (block 1050). For example, the network node (e.g., using reception component 1202 and/or communication manager 1208, depicted in FIG. 12) may receive, from the first DU, an indication of a UE context modification response, as described above.

As further shown in FIG. 10, in some aspects, process 1000 may include transmitting, to the second DU, an indication of a UE context setup request associated with the second cell (block 1060). For example, the network node (e.g., using transmission component 1204 and/or communication manager 1208, depicted in FIG. 12) may transmit, to the second DU, an indication of a UE context setup request associated with the second cell, as described above.

As further shown in FIG. 10, in some aspects, process 1000 may include receiving, from the second DU, an indication of a UE context setup response (block 1070). For example, the network node (e.g., using reception component 1202 and/or communication manager 1208, depicted in FIG. 12) may receive, from the second DU, an indication of a UE context setup response, as described above.

Process 1000 may include additional aspects, such as any single aspect or any combination of aspects described below and/or in connection with one or more other processes described elsewhere herein.

In a first aspect, process 1000 includes establishing network interfaces with the CU and with the one or more DUs.

In a second aspect, alone or in combination with the first aspect, the network interfaces comprise an F1 interface.

In a third aspect, alone or in combination with one or more of the first and second aspects, process 1000 includes receiving a configuration for mapping the CU to the one or more DUs.

In a fourth aspect, alone or in combination with one or more of the first through third aspects, process 1000 includes establishing a connection with the DU, releasing the connection with the DU, suspending the connection with the DU, or resuming the connection with the DU.

In a fifth aspect, alone or in combination with one or more of the first through fourth aspects, the connection availability between the network node and the DU is based at least in part on movement of the DU.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1108, which may be in communication with one another (for example, via one or more buses and/or one or more other components).

In some aspects, the communication manager 1108 is the communication manager 150 described in connection with FIG. 1. As shown, the apparatus 1100 may communicate with another apparatus 1106, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 6-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1104 may be co-located with the reception component 1102 in one or more transceivers.

The communication manager 1108 may support operations of the reception component 1102 and/or the transmission component 1104. For example, the communication manager 1108 may receive information associated with configuring reception of communications by the reception component 1102 and/or transmission of communications by the transmission component 1104. Additionally, or alternatively, the communication manager 1108 may generate and/or provide control information to the reception component 1102 and/or the transmission component 1104 to control reception and/or transmission of communications.

The communication manager 1108 may establish a network interface link with a CU. The communication manager 1108 may establish a set of one or more network interface links with a set of one or more DUs. The reception component 1102 may receive a first communication intended for a destination node via the network interface link. The transmission component 1104 may transmit the first communication to a first DU of the set of one or more DUs via a first network interface link of the set of one or more network interface links. The reception component 1102 may receive a second communication intended for the destination node via the network interface link. The transmission component 1104 may transmit, after transmitting the first communication via the first network interface link, the second communication to a second DU via a second network interface link.

The communication manager 1108 may release, suspend, or resume the first network interface link after transmitting the first communication, wherein releasing, suspending, or resuming the first network interface link is based at least in part on a connection availability between the network node and the first DU and is independent from the network interface link with the CU.

The communication manager 1108 may perform a network interface link setup associated with the second network interface link before transmitting the second communication wherein the network interface link setup associated with the second network interface link is independent from the network interface link with the CU.

The reception component 1102 may receive, from the CU, an indication of an intra-DU handover from the first DU associated with the first network interface link to the second DU associated with the second network interface link.

The communication manager 1108 may perform an inter-DU handover from the first DU to the second DU.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1208, which may be in communication with one another (for example, via one or more buses and/or one or more other components). In some aspects, the communication manager 1208 is the communication manager 150 described in connection with FIG. 1. As shown, the apparatus 1200 may communicate with another apparatus 1206, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 6-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1204 may be co-located with the reception component 1202 in one or more transceivers.

The communication manager 1208 may support operations of the reception component 1202 and/or the transmission component 1204. For example, the communication manager 1208 may receive information associated with configuring reception of communications by the reception component 1202 and/or transmission of communications by the transmission component 1204. Additionally, or alternatively, the communication manager 1208 may generate and/or provide control information to the reception component 1202 and/or the transmission component 1204 to control reception and/or transmission of communications.

The reception component 1202 and/or the transmission component 1204 may communicate with a CU. The reception component 1202 and/or the transmission component 1204 may communicate with a set of one or more DUs. The reception component 1202 may receive, from the CU, an indication of a handover from a first cell associated with a first DU to a second cell associated with a second DU. The transmission component 1204 may transmit, to the first DU, an indication of a UE context modification request associated with the first cell. The reception component 1202 may receive, from the first DU, an indication of a UE context modification response. The transmission component 1204 may transmit, to the second DU, an indication of a UE context setup request associated with the second cell. The reception component 1202 may receive, from the second DU, an indication of a UE context setup response.

The communication manager 1208 may establish network interfaces with the CU and with the one or more DUs.

The reception component 1202 may receive a configuration for mapping the CU to the one or more DUs.

The communication manager 1208 may establish a connection with the DU.

The communication manager 1208 may release the connection with the DU.

The communication manager 1208 may suspend the connection with the DU.

The communication manager 1208 may resume the connection with the DU.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

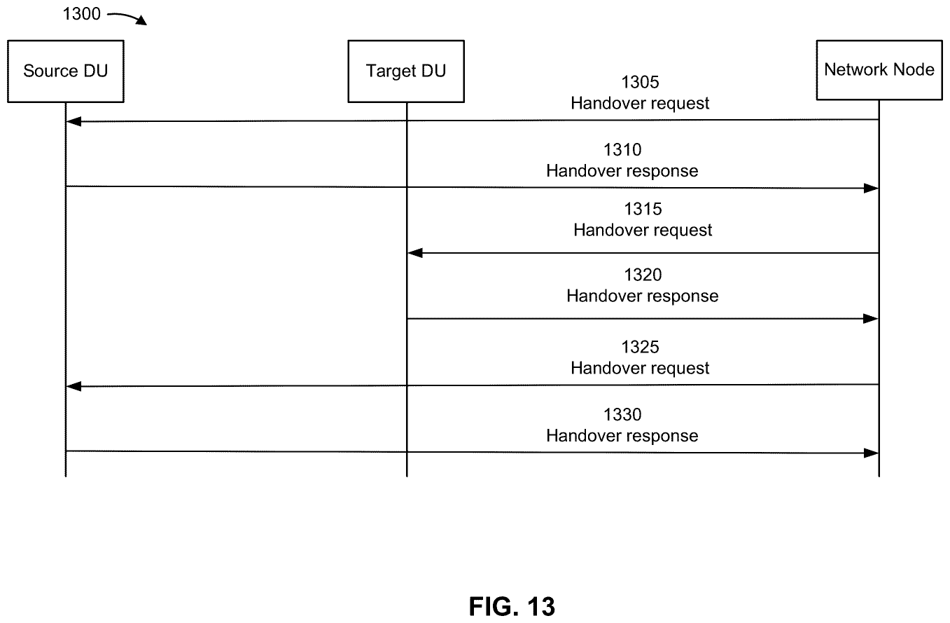

FIG. 13 is a diagram illustrating an example 1300 of handovers, in accordance with the present disclosure. As shown in FIG. 13, a network node may manage a handover from a source DU to a target DU.

As shown by reference number 1305, the network node may transmit a handover request to the source DU. In some aspects, the handover request may include a UE context modification request. As shown by reference number 1310, the source DU may transmit a handover response to the network node. In some aspects, the handover response may include a UE context modification response.

As shown by reference number 1315, the network node may transmit a handover request to the target DU. In some aspects, the handover request may include a UE context setup request. As shown by reference number 1320, the source DU may transmit a handover response to the network node. In some aspects, the handover response may include a UE context setup response.

As shown by reference number 1325, the network node may transmit a handover request to the source DU. In some aspects, the handover request may include a UE context modification request. In some aspects, the handover request may include an RRC reconfiguration message. As shown by reference number 1330, the source DU may transmit a handover response to the network node. In some aspects, the handover response may include a UE context modification response. In some aspects, the handover response may include an RRC complete message.

As indicated above, FIG. 13 is provided as an example. Other examples may differ from what is described with respect to FIG. 13.

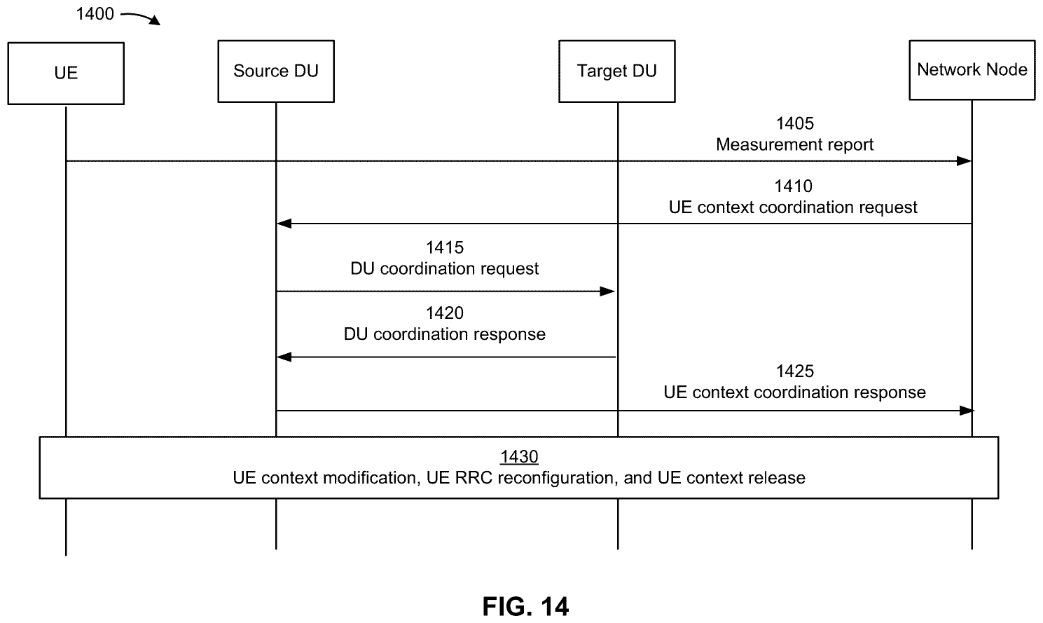

FIGS. 14-17 are diagrams illustrating examples 1400, 1500, 1600, and 1700 of handovers, in accordance with the present disclosure. As shown in FIGS. 14-17, a network node may manage a handover from a source DU to a target DU. As further shown in FIGS. 14-17, and in contrast to FIG. 13, the network node may transmit a single message to the source DU or target DU and may receive a single message back from the source DU or target DU in association with the handover.

In the context of FIGS. 14-17, the network node may include CU that communicates directly or indirectly with the source DU and the target DU. Alternatively, the network node may include an NTN gateway that manages the source DU and the target DU as in intermediary for a CU (e.g., as shown in FIGS. 6-8).

As shown by reference number 1405, the network node may receive, and the UE may transmit, a measurement report. The measurement report may indicate that a handover from the source DU to the target DU may improve a link between the UE and the network node. For example, the measurement report may indicate an RSRP or signal-to-noise ratio (SNR) of signals of the source DU and/or the target DU, as received at the UE.

As shown by reference number 1410, the network node may transmit a UE context coordination request to the source DU. The UE context coordination request may include information associated with a UE context modification request and a context setup request. For example, the UE context coordination request may include all or some content that may have been included in the handover requests described in connection with reference numbers 1305 and 1315 of FIG. 13.

As shown by reference number 1415, the source DU may transmit a DU coordination request to the target DU. The DU coordination request may include UE context setup information. In some aspects, the source DU may provide configuration information associated with communicating with the UE as part of the DU coordination request.

As shown by reference number 1420, the source DU may receive a DU coordination response from the target DU. The DU coordination request may include UE context setup response information.

As shown by reference number 1425, the source DU may transmit a UE context coordination response to the network node. In some aspects, the UE context coordination response may include all or part of a UE context modification response and/or a UE context setup response.

As shown by reference number 1430, the devices of FIG. 14 may complete a handover by performing one or more of UE context modification, UE RRC reconfiguration, and/or UE context release.

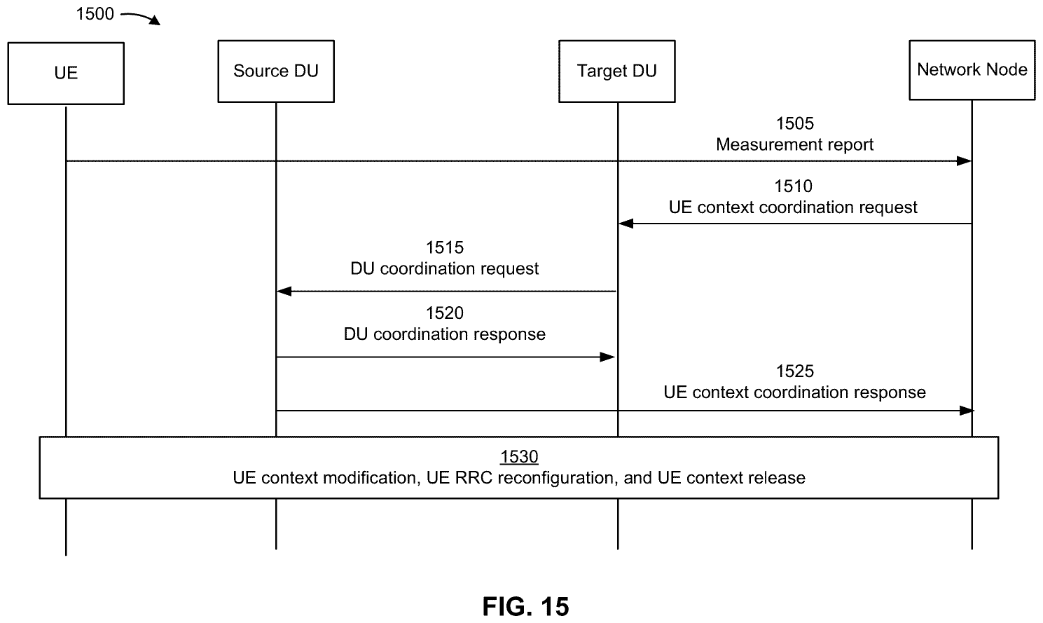

As shown in FIG. 15, and by reference number 1505, the network node may receive, and the UE may transmit, a measurement report. The measurement report may indicate that a handover from the source DU to the target DU may improve a link between the UE and the network node. For example, the measurement report may indicate an RSRP or SNR of signals of the source DU and/or the target DU, as received at the UE.

As shown by reference number 1510, the network node may transmit a UE context coordination request to the target DU. The UE context coordination request may include information associated with a UE context modification request and a context setup request. For example, the UE context coordination request may include all or some content that may have been included in the handover requests 1305 and 1315 of FIG. 13.

As shown by reference number 1515, the target DU may transmit a DU coordination request to the source DU. The DU coordination request may include UE context setup information.

As shown by reference number 1520, the target DU may receive a DU coordination response from the source DU. The DU coordination request may include UE context setup response information. In some aspects, the source DU may provide configuration information associated with communicating with the UE as part of the DU coordination response.

As shown by reference number 1525, the source DU may transmit a UE context coordination response to the network node. In some aspects, the UE context coordination response may include all or part of a UE context modification response and/or a UE context setup response.

As shown by reference number 1530, the devices of FIG. 15 may complete a handover by performing one or more of UE context modification, UE RRC reconfiguration, and/or UE context release.

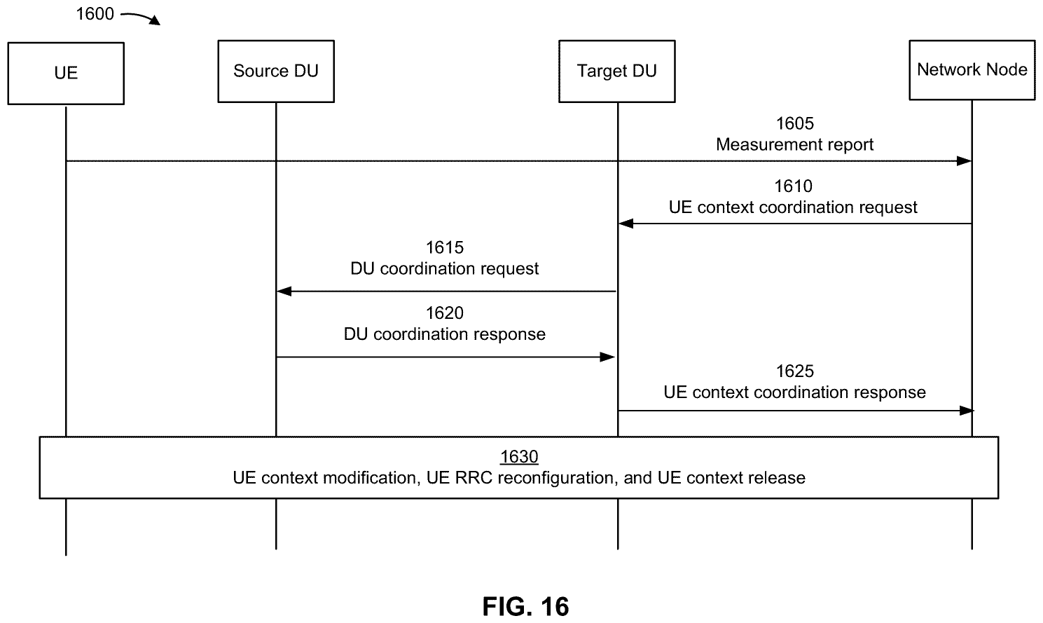

As shown in FIG. 16, and by reference number 1605, the network node may receive, and the UE may transmit, a measurement report. The measurement report may indicate that a handover from the source DU to the target DU may improve a link between the UE and the network node. For example, the measurement report may indicate an RSRP or SNR of signals of the source DU and/or the target DU, as received at the UE.

As shown by reference number 1610, the network node may transmit a UE context coordination request to the target DU. The UE context coordination request may include information associated with a UE context modification request and a context setup request. For example, the UE context coordination request may include all or some content that may have been included in the handover requests 1305 and 1315 of FIG. 13.

As shown by reference number 1615, the target DU may transmit a DU coordination request to the source DU. The DU coordination request may include UE context setup information.

As shown by reference number 1620, the target DU may receive a DU coordination response from the source DU. The DU coordination request may include UE context setup response information. In some aspects, the source DU may provide configuration information associated with communicating with the UE as part of the DU coordination response.

As shown by reference number 1625, the target DU may transmit a UE context coordination response to the network node. In some aspects, the UE context coordination response may include all or part of a UE context modification response and/or a UE context setup response.

As shown by reference number 1630, the devices of FIG. 16 may complete a handover by performing one or more of UE context modification, UE RRC reconfiguration, and/or UE context release.

As shown by reference number 1705, the network node may receive, and the UE may transmit, a measurement report. The measurement report may indicate that a handover from the source DU to the target DU may improve a link between the UE and the network node. For example, the measurement report may indicate an RSRP or SNR of signals of the source DU and/or the target DU, as received at the UE.

As shown by reference number 1710, the network node may transmit a UE context coordination request to the source DU. The UE context coordination request may include information associated with a UE context modification request and a context setup request. For example, the UE context coordination request may include all or some content that may have been included in the handover requests 1305 and 1315 of FIG. 13.

As shown by reference number 1715, the source DU may transmit a DU coordination request to the target DU. The DU coordination request may include UE context setup information. In some aspects, the source DU may provide configuration information associated with communicating with the UE as part of the DU coordination request.

As shown by reference number 1720, the source DU may receive a DU coordination response from the target DU. The DU coordination request may include UE context setup response information.

As shown by reference number 1725, the target DU may transmit a UE context coordination response to the network node. In some aspects, the UE context coordination response may include all or part of a UE context modification response and/or a UE context setup response.

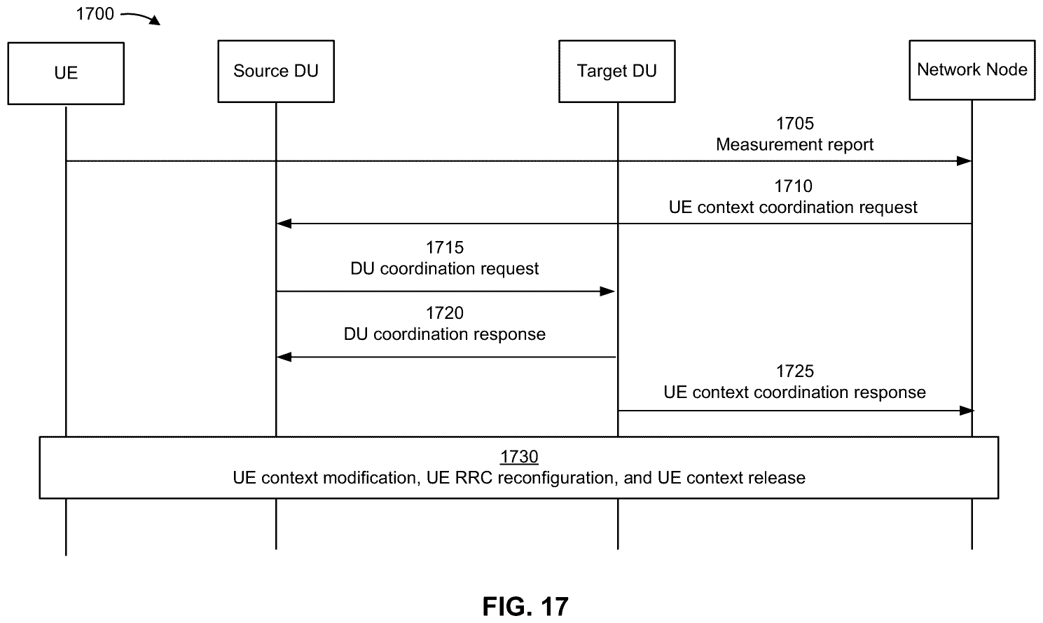

As shown by reference number 1730, the devices of FIG. 17 may complete a handover by performing one or more of UE context modification, UE RRC reconfiguration, and/or UE context release.

As indicated above, FIGS. 14-17 are provided as examples. Other examples may differ from what is described with respect to FIGS. 14-17.

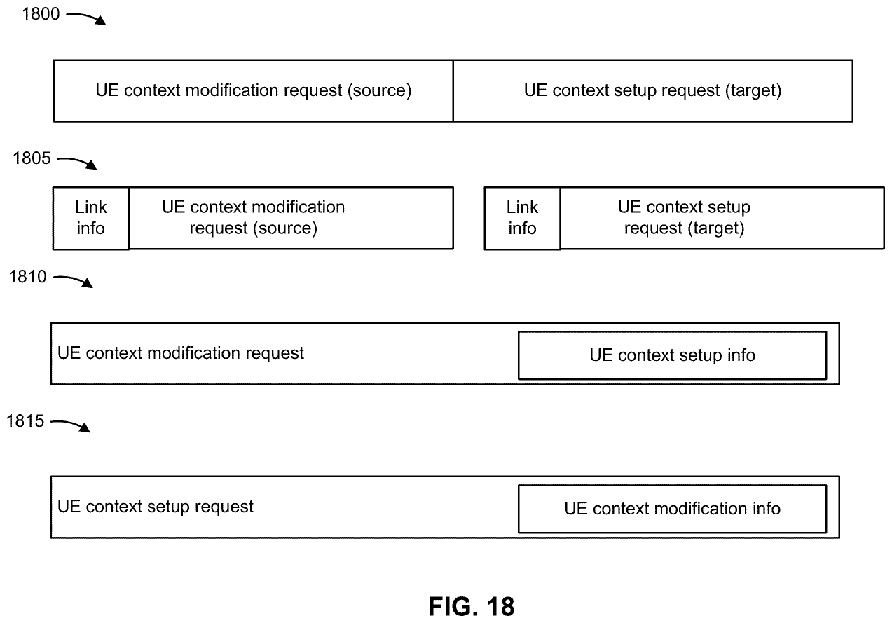

FIG. 18 is a diagram illustrating examples 1800, 1805, 1810, and 1815 of UE context coordination requests, in accordance with the present disclosure. In context of FIG. 18, a network node may manage a handover from a source DU to a target DU.

As shown in example 1800, a context coordination request may include a concatenation of a UE context modification request (e.g., for the source DU) and a UE context setup request (e.g., for the target DU). In this configuration, a receiving DU may read the message intended for the receiving DU and forward the message intended for a non-receiving DU to the non-receiving DU.

As shown in example 1805, the context coordination request may include separate messages for the UE context modification request and the UE context setup request. As shown in example 1805, each message may include link information that indicates a link between the messages. In this way, a receiving DU may recognize both messages as being associated with a single handover request.

As shown in example 1810, the context coordination request may include a UE context modification request that indicates UE context setup information. For example, one or more fields of the UE context modification request may include the UE context setup information.

As shown in example 1815, the context coordination request may include a UE context setup request that indicates UE context modification information. For example, one or more fields of the UE context setup request may include the UE context modification information.

As indicated above, FIG. 18 is provided as an example. Other examples may differ from what is described with respect to FIG. 18.

FIG. 19 is a diagram illustrating an example process 1900 performed, for example, at a network node or an apparatus of a network node, in accordance with the present disclosure. Example process 1900 is an example where the apparatus or the network node (e.g., network node 110) performs operations associated with UE context coordination requests.

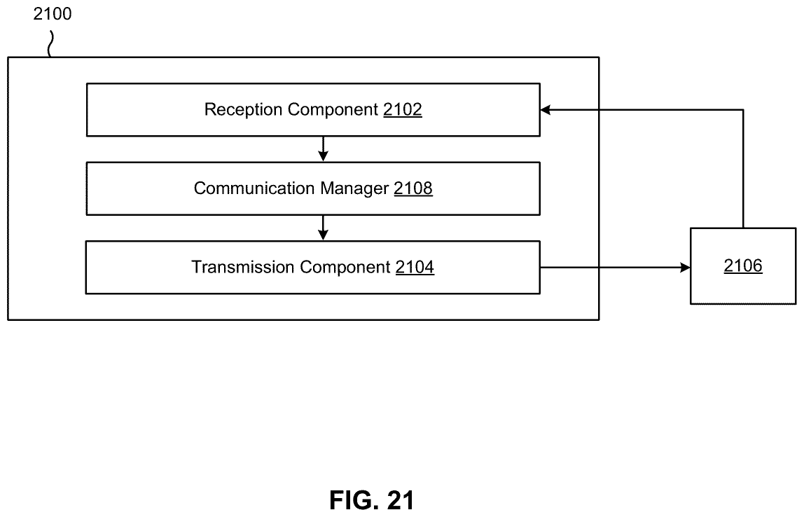

As shown in FIG. 19, in some aspects, process 1900 may include communicating with a UE via a source DU (block 1910). For example, the network node (e.g., using reception component 2102, transmission component 2104, and/or communication manager 2108, depicted in FIG. 21) may communicate with a UE via a source DU, as described above.

As further shown in FIG. 19, in some aspects, process 1900 may include transmitting, to one of the source DU or the target DU, a request for coordination associated with the handover (block 1920). For example, the network node (e.g., using transmission component 2104 and/or communication manager 2108, depicted in FIG. 21) may transmit, to one of the source DU or the target DU, a request for coordination associated with the handover, as described above.

As further shown in FIG. 19, in some aspects, process 1900 may include receiving, from one of the source DU or the target DU, a response to the request for the coordination (block 1930). For example, the network node (e.g., using reception component 2102 and/or communication manager 2108, depicted in FIG. 21) may receive, from one of the source DU or the target DU, a response to the request for the coordination, as described above.

Process 1900 may include additional aspects, such as any single aspect or any combination of aspects described below and/or in connection with one or more other processes described elsewhere herein.

In a first aspect, the response comprises UE context modification information.

In a second aspect, alone or in combination with the first aspect, transmitting the request comprises transmitting the request to the source DU, and wherein receiving the response comprises receiving the response from the source DU.

In a third aspect, alone or in combination with one or more of the first and second aspects, transmitting the request comprises transmitting the request to the source DU, and wherein receiving the response comprises receiving the response from the target DU.

In a fourth aspect, alone or in combination with one or more of the first through third aspects, transmitting the request comprises transmitting the request to the target DU, and wherein receiving the response comprises receiving the response from the target DU.

In a fifth aspect, alone or in combination with one or more of the first through fourth aspects, transmitting the request comprises transmitting the request to the target DU, and wherein receiving the response comprises receiving the response from the source DU.

In a sixth aspect, alone or in combination with one or more of the first through fifth aspects, the request comprises an indication of one or more of UE-specific information, source cell information associated with the source DU, candidate target cell information associated with the target DU, new CU configuration information, or a handover cause value.

In a seventh aspect, alone or in combination with one or more of the first through sixth aspects, transmitting the request comprises transmitting the request via a UE context modification request message and a UE context setup request message, a UE context modification request message that includes UE context setup information, or a UE context setup request message that includes UE context modification information.

In an eighth aspect, alone or in combination with one or more of the first through seventh aspects, receiving the response comprises receiving the response via one or more of a UE context modification response message and a UE context setup response message, a UE context modification response message that includes UE setup response information, or a UE context setup response message that includes UE setup response information.

In a ninth aspect, alone or in combination with one or more of the first through eighth aspects, the network node comprises a gateway network node that facilitates communications between the source DU and a CU and between the target DU and the Cu.

In a tenth aspect, alone or in combination with one or more of the first through ninth aspects, process 1900 includes receiving an indication of signal measurements associated with triggering a handover from the source DU to a target DU, wherein transmitting the request for coordination is based at least in part on reception of the indication of the signal measurements.

Although FIG. 19 shows example blocks of process 1900, in some aspects, process 1900 may include additional blocks, fewer blocks, different blocks, or differently arranged blocks than those depicted in FIG. 19. Additionally, or alternatively, two or more of the blocks of process 1900 may be performed in parallel.

FIG. 20 is a diagram illustrating an example process 2000 performed, for example, at a DU or an apparatus of a DU, in accordance with the present disclosure.

Example process 2000 is an example where the apparatus or the DU (e.g., DUs 715, 815, a source DU, a target DU, and/or network node 110, among other examples) performs operations associated with UE context coordination requests.

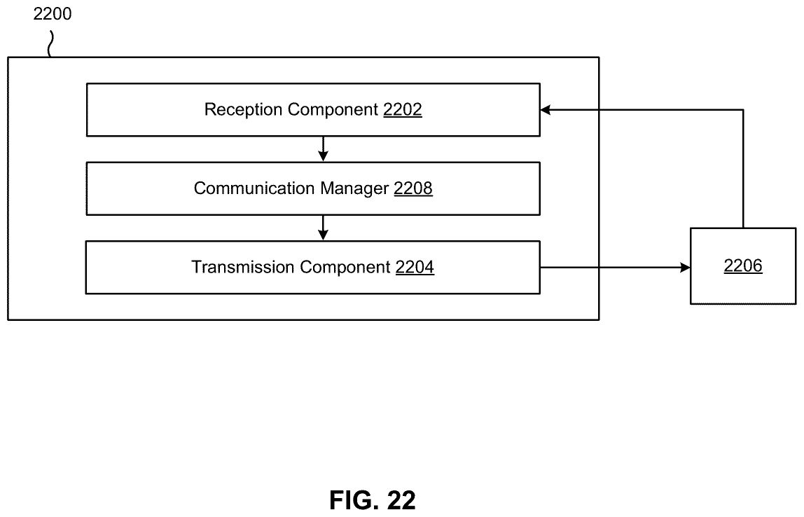

As shown in FIG. 20, in some aspects, process 2000 may include receiving, directly or indirectly from a CU, a request for coordination of a handover associated with a UE and a second DU (block 2010). For example, the DU (e.g., using reception component 2202 and/or communication manager 2208, depicted in FIG. 22) may receive, directly or indirectly from a CU, a request for coordination of a handover associated with a UE and a second DU, as described above.

As further shown in FIG. 20, in some aspects, process 2000 may include communicating, with the second DU, handover coordination information (block 2020).

For example, the DU (e.g., using reception component 2202, transmission component 2204, and/or communication manager 2208, depicted in FIG. 22) may communicate, with the second DU, handover coordination information, as described above.

Process 2000 may include additional aspects, such as any single aspect or any combination of aspects described below and/or in connection with one or more other processes described elsewhere herein.

In a first aspect, process 2000 includes transmitting, directly or indirectly to the CU, a response to the request.

In a second aspect, alone or in combination with the first aspect, communicating with the second DU comprises communicating via one or more of an optical link, or an RF link.

In a third aspect, alone or in combination with one or more of the first and second aspects, receiving the request for coordination comprises receiving the request for coordination via the second DU and transmitting a response to the second DU, or transmitting the request for coordination to the second DU and receiving a response from the second DU.

In a fourth aspect, alone or in combination with one or more of the first through third aspects, the response comprises UE context modification information.

In a fifth aspect, alone or in combination with one or more of the first through fourth aspects, the response comprises one or more of a UE context modification response message and a UE context setup response message, a UE context modification response message that includes UE setup response information, or a UE context setup response message that includes UE setup response information.

In a sixth aspect, alone or in combination with one or more of the first through fifth aspects, receiving the request comprises receiving the request via a UE context modification request message and a UE context setup request message, a UE context modification request message that includes UE context setup information, or a UE context setup request message that includes UE context modification information.

In a seventh aspect, alone or in combination with one or more of the first through sixth aspects, the first DU comprises a source DU and the second DU comprises a target DU, or wherein the second DU comprises the source DU and the first DU comprises the target DU.

In an eighth aspect, alone or in combination with one or more of the first through seventh aspects, the handover coordination information comprises one or more of UE-specific information, source cell information associated with one of the first DU or the second DU, candidate target cell information associated with one of the first DU or the second DU, new CU configuration information, a handover cause value, a current DU configuration associated with the UE, or a new DU configuration associated with the UE.

In a ninth aspect, alone or in combination with one or more of the first through eighth aspects, the request comprises an indication of one or more of UE-specific information, source cell information associated with one of the first DU or the second DU, candidate target cell information associated with one of the first DU or the second DU, new CU configuration information, or a handover cause value.

In a tenth aspect, alone or in combination with one or more of the first through ninth aspects, receiving the request comprises receiving the request via a UE context modification request message and a UE context setup request message, a UE context modification request that includes UE context setup information, or a UE context setup request that includes UE context modification information.

In an eleventh aspect, alone or in combination with one or more of the first through tenth aspects, receiving the request indirectly from the CU comprises receiving the request via a gateway network node that facilitates communications between the first DU and the CU and between the second DU and the CU.

Although FIG. 20 shows example blocks of process 2000, in some aspects, process 2000 may include additional blocks, fewer blocks, different blocks, or differently arranged blocks than those depicted in FIG. 20. Additionally, or alternatively, two or more of the blocks of process 2000 may be performed in parallel.

FIG. 21 is a diagram of an example apparatus 2100 for wireless communication, in accordance with the present disclosure. The apparatus 2100 may be a network node, or a network node may include the apparatus 2100. In some aspects, the apparatus 2100 includes a reception component 2102, a transmission component 2104, and/or a communication manager 2108, which may be in communication with one another (for example, via one or more buses and/or one or more other components). In some aspects, the communication manager 2108 is the communication manager 150 described in connection with FIG. 1. As shown, the apparatus 2100 may communicate with another apparatus 2106, such as a UE or a network node (such as a CU, a DU, an RU, or a base station), using the reception component 2102 and the transmission component 2104.

In some aspects, the apparatus 2100 may be configured to perform one or more operations described herein in connection with FIGS. 14-18. Additionally, or alternatively, the apparatus 2100 may be configured to perform one or more processes described herein, such as process 1900 of FIG. 19. In some aspects, the apparatus 2100 and/or one or more components shown in FIG. 21 may include one or more components of the network node described in connection with FIG. 2. Additionally, or alternatively, one or more components shown in FIG. 21 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 2102 may receive communications, such as reference signals, control information, data communications, or a combination thereof, from the apparatus 2106. The reception component 2102 may provide received communications to one or more other components of the apparatus 2100. In some aspects, the reception component 2102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2100. In some aspects, the reception component 2102 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 2102 and/or the transmission component 2104 may include or may be included in a network interface. The network interface may be configured to obtain and/or output signals for the apparatus 2100 via one or more communications links, such as a backhaul link, a midhaul link, and/or a fronthaul link.

The transmission component 2104 may transmit communications, such as reference signals, control information, data communications, or a combination thereof, to the apparatus 2106. In some aspects, one or more other components of the apparatus 2100 may generate communications and may provide the generated communications to the transmission component 2104 for transmission to the apparatus 2106. In some aspects, the transmission component 2104 may perform signal processing on the generated communications (such as filtering, amplification, modulation, digital-to-analog conversion, multiplexing, interleaving, mapping, or encoding, among other examples), and may transmit the processed signals to the apparatus 2106. In some aspects, the transmission component 2104 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 2104 may be co-located with the reception component 2102 in one or more transceivers.

The communication manager 2108 may support operations of the reception component 2102 and/or the transmission component 2104. For example, the communication manager 2108 may receive information associated with configuring reception of communications by the reception component 2102 and/or transmission of communications by the transmission component 2104. Additionally, or alternatively, the communication manager 2108 may generate and/or provide control information to the reception component 2102 and/or the transmission component 2104 to control reception and/or transmission of communications.

The reception component 2102 and/or the transmission component 2104 may communicate with a UE via a source DU. The transmission component 2104 may transmit, to one of the source DU or the target DU, a request for coordination associated with the handover. The reception component 2102 may receive, from one of the source DU or the target DU, a response to the request for the coordination.

The reception component 2102 may receive an indication of signal measurements associated with triggering a handover from the source DU to a target DU wherein transmitting the request for coordination is based at least in part on reception of the indication of the signal measurements.

The number and arrangement of components shown in FIG. 21 are provided as an example. In practice, there may be additional components, fewer components, different components, or differently arranged components than those shown in FIG. 21. Furthermore, two or more components shown in FIG. 21 may be implemented within a single component, or a single component shown in FIG. 21 may be implemented as multiple, distributed components. Additionally, or alternatively, a set of (one or more) components shown in FIG. 21 may perform one or more functions described as being performed by another set of components shown in FIG. 21.

FIG. 22 is a diagram of an example apparatus 2200 for wireless communication, in accordance with the present disclosure. The apparatus 2200 may be a first DU, or a first DU may include the apparatus 2200. In some aspects, the apparatus 2200 includes a reception component 2202, a transmission component 2204, and/or a communication manager 2208, which may be in communication with one another (for example, via one or more buses and/or one or more other components). In some aspects, the communication manager 2208 is the communication manager 150 described in connection with FIG. 1. As shown, the apparatus 2200 may communicate with another apparatus 2206, such as a UE or a network node (such as a CU, a DU, an RU, or a base station), using the reception component 2202 and the transmission component 2204.

In some aspects, the apparatus 2200 may be configured to perform one or more operations described herein in connection with FIGS. 14-18. Additionally, or alternatively, the apparatus 2200 may be configured to perform one or more processes described herein, such as process 2000 of FIG. 20. In some aspects, the apparatus 2200 and/or one or more components shown in FIG. 22 may include one or more components of the first DU described in connection with FIG. 2. Additionally, or alternatively, one or more components shown in FIG. 22 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 2202 may receive communications, such as reference signals, control information, data communications, or a combination thereof, from the apparatus 2206. The reception component 2202 may provide received communications to one or more other components of the apparatus 2200. In some aspects, the reception component 2202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2200. In some aspects, the reception component 2202 may include one or more antennas, one or more modems, one or more demodulators, one or more MIMO detectors, one or more receive processors, one or more controllers/processors, one or more memories, or a combination thereof, of the first DU described in connection with FIG. 2.

The transmission component 2204 may transmit communications, such as reference signals, control information, data communications, or a combination thereof, to the apparatus 2206. In some aspects, one or more other components of the apparatus 2200 may generate communications and may provide the generated communications to the transmission component 2204 for transmission to the apparatus 2206. In some aspects, the transmission component 2204 may perform signal processing on the generated communications (such as filtering, amplification, modulation, digital-to-analog conversion, multiplexing, interleaving, mapping, or encoding, among other examples), and may transmit the processed signals to the apparatus 2206. In some aspects, the transmission component 2204 may include one or more antennas, one or more modems, one or more modulators, one or more transmit MIMO processors, one or more transmit processors, one or more controllers/processors, one or more memories, or a combination thereof, of the first DU described in connection with FIG. 2. In some aspects, the transmission component 2204 may be co-located with the reception component 2202 in one or more transceivers.

The communication manager 2208 may support operations of the reception component 2202 and/or the transmission component 2204. For example, the communication manager 2208 may receive information associated with configuring reception of communications by the reception component 2202 and/or transmission of communications by the transmission component 2204. Additionally, or alternatively, the communication manager 2208 may generate and/or provide control information to the reception component 2202 and/or the transmission component 2204 to control reception and/or transmission of communications.

The reception component 2202 may receive, directly or indirectly from a CU, a request for coordination of a handover associated with a UE and a second DU. The reception component 2202 and/or the transmission component 2204 may communicate, with the second DU, handover coordination information.

The transmission component 2204 may transmit, directly or indirectly to the CU, a response to the request.

The number and arrangement of components shown in FIG. 22 are provided as an example. In practice, there may be additional components, fewer components, different components, or differently arranged components than those shown in FIG. 22. Furthermore, two or more components shown in FIG. 22 may be implemented within a single component, or a single component shown in FIG. 22 may be implemented as multiple, distributed components. Additionally, or alternatively, a set of (one or more) components shown in FIG. 22 may perform one or more functions described as being performed by another set of components shown in FIG. 22.

The following provides an overview of some Aspects of the present disclosure:

Aspect 1: A method of wireless communication performed by a network node, comprising: establishing a network interface link with a centralized unit (CU); establishing a set of one or more network interface links with a set of one or more distributed units (DUs); receiving a first communication intended for a destination node via the network interface link; transmitting the first communication to a first DU of the set of one or more DUs via a first network interface link of the set of one or more network interface links; receiving a second communication intended for the destination node via the network interface link; and transmitting, after transmitting the first communication via the first network interface link, the second communication to a second DU via a second network interface link.

Aspect 2: The method of Aspect 1, wherein the set of one or more network interface links comprises the second network interface link, or wherein the network node establishes the second network interface link after establishing the set of one or more network interface links.

Aspect 3: The method of any of Aspects 1-2, wherein transmitting the second communication to the second DU via the second network interface link comprises: transmitting the second communication to the second DU via the second network interface link based at least in part on one or more of movement or availability of the first DU associated with the first network interface link, availability of the first network interface link, movement or availability of the second DU associated with the second network interface link, or availability of the second network interface link.

Aspect 4: The method of any of Aspects 1-3, further comprising releasing, suspending, or resuming the first network interface link after transmitting the first communication, wherein releasing, suspending, or resuming the first network interface link is based at least in part on a connection availability between the network node and the first DU and is independent from the network interface link with the CU.

Aspect 5: The method of any of Aspects 1-4, further comprising performing a network interface link setup associated with the second network interface link before transmitting the second communication, wherein the network interface link setup associated with the second network interface link is independent from the network interface link with the CU.

Aspect 6: The method of any of Aspects 1-5, further comprising: receiving, from the CU, an indication of an intra-DU handover from the first DU associated with the first network interface link to the second DU associated with the second network interface link; and performing an inter-DU handover from the first DU to the second DU.

Aspect 7: The method of Aspect 6, wherein performing the inter-DU handover from the first DU to the second DU comprises: receiving, from the first DU, first configuration information associated with a first link between the first DU and the destination node; and transmitting, to the second DU, second configuration information, based at least in part on the first configuration information, associated with establishing a second link between the second DU and the destination node.

Aspect 8: The method of any of Aspects 1-7, wherein the network node comprises a gateway node.

Aspect 9: The method of any of Aspects 1-8, wherein the set of one or more DUs comprises a set of one or more non-terrestrial network (NTN) DUs.

Aspect 10: The method of any of Aspects 1-9, wherein the network interface link and the one or more network interface links comprise F1 interface links.

Aspect 11: A method of wireless communication performed by a network node, comprising: communicating with a centralized unit (CU); communicating with a set of one or more distributed units (DUs); receiving, from the CU, an indication of a handover from a first cell associated with a first DU to a second cell associated with a second DU; transmitting, to the first DU, an indication of a user equipment (UE) context modification request associated with the first cell; receiving, from the first DU, an indication of a UE context modification response; transmitting, to the second DU, an indication of a UE context setup request associated with the second cell; and receiving, from the second DU, an indication of a UE context setup response.

Aspect 12: The method of Aspect 11, further comprising: establishing network interfaces with the CU and with the one or more DUs.

Aspect 13: The method of Aspect 12, wherein the network interfaces comprise an F1 interface.

Aspect 14: The method of any of Aspects 11-13, further comprising: receiving a configuration for mapping the CU to the one or more DUs.

Aspect 15: The method of any of Aspects 11-14, further comprising, based at least in part on a connection availability between the network node and a DU of the one or more DUs, one or more of: establishing a connection with the DU; releasing the connection with the DU; suspending the connection with the DU; or resuming the connection with the DU.

Aspect 16: The method of Aspect 15, wherein the connection availability between the network node and the DU is based at least in part on movement of the DU.

Aspect 17: A method of wireless communication performed by a network node, comprising: communicating with a user equipment (UE) via a source distributed unit (DU); transmitting, to one of the source DU or the target DU, a request for coordination associated with the handover; and receiving, from one of the source DU or the target DU, a response to the request for the coordination.

Aspect 18: The method of Aspect 17, wherein the response comprises UE context modification information.

Aspect 19: The method of any of Aspects 17-18, wherein transmitting the request comprises transmitting the request to the source DU, and wherein receiving the response comprises receiving the response from the source DU.

Aspect 20: The method of any of Aspects 17-19, wherein transmitting the request comprises transmitting the request to the source DU, and wherein receiving the response comprises receiving the response from the target DU.

Aspect 21: The method of any of Aspects 17-20, wherein transmitting the request comprises transmitting the request to the target DU, and wherein receiving the response comprises receiving the response from the target DU.

Aspect 22: The method of any of Aspects 17-21, wherein transmitting the request comprises transmitting the request to the target DU, and wherein receiving the response comprises receiving the response from the source DU.

Aspect 23: The method of any of Aspects 17-22, wherein the request comprises an indication of one or more of: UE-specific information, source cell information associated with the source DU, candidate target cell information associated with the target DU, new central unit (CU) configuration information, or a handover cause value.

Aspect 24: The method of any of Aspects 17-23, wherein transmitting the request comprises transmitting the request via: a UE context modification request message and a UE context setup request message, a UE context modification request message that includes UE context setup information, or a UE context setup request message that includes UE context modification information.

Aspect 25: The method of any of Aspects 17-24, wherein receiving the response comprises receiving the response via one or more of: a UE context modification response message and a UE context setup response message, a UE context modification response message that includes UE setup response information, or a UE context setup response message that includes UE setup response information.

Aspect 26: The method of any of Aspects 17-25, wherein the network node comprises a gateway network node that facilitates communications between the source DU and a central unit (CU) and between the target DU and the CU.

Aspect 27: The method of any of Aspects 17-26, further comprising receiving an indication of signal measurements associated with triggering a handover from the source DU to a target DU, wherein transmitting the request for coordination is based at least in part on reception of the indication of the signal measurements.

Aspect 28: A method of wireless communication performed by a first distributed unit (DU), comprising: receiving, directly or indirectly from a central unit (CU), a request for coordination of a handover associated with a user equipment (UE) and a second DU; and communicating, with the second DU, handover coordination information.

Aspect 29: The method of Aspect 28, further comprising: transmitting, directly or indirectly to the CU, a response to the request.

Aspect 30: The method of any of Aspects 28-29, wherein communicating with the second DU comprises communicating via one or more of: an optical link, or a radio frequency (RF) link.

Aspect 31: The method of any of Aspects 28-30, wherein receiving the request for coordination comprises: receiving the request for coordination via the second DU and transmitting a response to the second DU, or transmitting the request for coordination to the second DU and receiving a response from the second DU.

Aspect 32: The method of Aspect 31, wherein the response comprises UE context modification information.

Aspect 33: The method of Aspect 31, wherein the response comprises one or more of: a UE context modification response message and a UE context setup response message, a UE context modification response message that includes UE setup response information, or a UE context setup response message that includes UE setup response information.

Aspect 34: The method of any of Aspects 28-33, wherein receiving the request comprises receiving the request via: a UE context modification request message and a UE context setup request message, a UE context modification request message that includes UE context setup information, or a UE context setup request message that includes UE context modification information.

Aspect 35: The method of any of Aspects 28-34, wherein the first DU comprises a source DU and the second DU comprises a target DU, or wherein the second DU comprises the source DU and the first DU comprises the target DU.

Aspect 36: The method of any of Aspects 28-35, wherein the handover coordination information comprises one or more of: UE-specific information, source cell information associated with one of the first DU or the second DU, candidate target cell information associated with one of the first DU or the second DU, new central unit (CU) configuration information, a handover cause value, a current DU configuration associated with the UE, or a new DU configuration associated with the UE.

Aspect 37: The method of any of Aspects 28-36, wherein the request comprises an indication of one or more of: UE-specific information, source cell information associated with one of the first DU or the second DU, candidate target cell information associated with one of the first DU or the second DU, new central unit (CU) configuration information, or a handover cause value.

Aspect 38: The method of any of Aspects 28-37, wherein receiving the request comprises receiving the request via: a UE context modification request message and a UE context setup request message, a UE context modification request that includes UE context setup information, or a UE context setup request that includes UE context modification information.

Aspect 39: The method of any of Aspects 28-38, wherein receiving the request indirectly from the CU comprises: receiving the request via a gateway network node that facilitates communications between the first DU and the CU and between the second DU and the CU.

Aspect 40: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-39.

Aspect 41: An apparatus for wireless communication at a device, the apparatus comprising one or more memories and one or more processors coupled to the one or more memories, the one or more processors configured to cause the device to perform the method of one or more of Aspects 1-39.

Aspect 42: An apparatus for wireless communication, the apparatus comprising at least one means for performing the method of one or more of Aspects 1-39.

Aspect 43: A non-transitory computer-readable medium storing code for wireless communication, the code comprising instructions executable by one or more processors to perform the method of one or more of Aspects 1-39.

Aspect 44: A non-transitory computer-readable medium storing a set of instructions for wireless communication, the set of instructions comprising one or more instructions that, when executed by one or more processors of a device, cause the device to perform the method of one or more of Aspects 1-39.

Aspect 45: A device for wireless communication, the device comprising a processing system that includes one or more processors and one or more memories coupled with the one or more processors, the processing system configured to cause the device to perform the method of one or more of Aspects 1-39.

Aspect 46: An apparatus for wireless communication at a device, the apparatus comprising one or more memories and one or more processors coupled to the one or more memories, the one or more processors individually or collectively configured to cause the device to perform the method of one or more of Aspects 1-39.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a network node, comprising:
establishing a network interface link with a centralized unit (CU);
establishing a set of one or more network interface links with a set of one or more distributed units (DUs);
receiving a first communication intended for a destination node via the network interface link;
transmitting the first communication to a first DU of the set of one or more DUs via a first network interface link of the set of one or more network interface links;
receiving a second communication intended for the destination node via the network interface link; and
transmitting, after transmitting the first communication via the first network interface link, the second communication to a second DU via a second network interface link.

2. The method of claim 1, wherein the set of one or more network interface links comprises the second network interface link, or
wherein the network node establishes the second network interface link after establishing the set of one or more network interface links.

3. The method of claim 1, wherein transmitting the second communication to the second DU via the second network interface link comprises:
transmitting the second communication to the second DU via the second network interface link based at least in part on one or more of movement or availability of the first DU associated with the first network interface link, availability of the first network interface link, movement or availability of the second DU associated with the second network interface link, or availability of the second network interface link.

4. The method of claim 1, further comprising releasing, suspending, or resuming the first network interface link after transmitting the first communication,
wherein releasing, suspending, or resuming the first network interface link is based at least in part on a connection availability between the network node and the first DU and is independent from the network interface link with the CU.

5. The method of claim 1, further comprising performing a network interface link setup associated with the second network interface link before transmitting the second communication,
wherein the network interface link setup associated with the second network interface link is independent from the network interface link with the CU.

6. The method of claim 1, further comprising:
receiving, from the CU, an indication of an intra-DU handover from the first DU associated with the first network interface link to the second DU associated with the second network interface link; and
performing an inter-DU handover from the first DU to the second DU.

7. The method of claim 6, wherein performing the inter-DU handover from the first DU to the second DU comprises:
receiving, from the first DU, first configuration information associated with a first link between the first DU and the destination node; and
transmitting, to the second DU, second configuration information, based at least in part on the first configuration information, associated with establishing a second link between the second DU and the destination node.

8. The method of claim 1, wherein the network node comprises a gateway node.

9. The method of claim 1, wherein the set of one or more DUs comprises a set of one or more non-terrestrial network (NTN) DUs.

10. The method of claim 1, wherein the network interface link and the one or more network interface links comprise F1 interface links.

11. A method of wireless communication performed by a network node, comprising:
communicating with a centralized unit (CU);
communicating with a set of one or more distributed units (DUs);
receiving, from the CU, an indication of a handover from a first cell associated with a first DU to a second cell associated with a second DU;
transmitting, to the first DU, an indication of a user equipment (UE) context modification request associated with the first cell;
receiving, from the first DU, an indication of a UE context modification response;
transmitting, to the second DU, an indication of a UE context setup request associated with the second cell; and
receiving, from the second DU, an indication of a UE context setup response.

12. The method of claim 11, further comprising:
establishing network interfaces with the CU and with the one or more DUs.

13. The method of claim 12, wherein the network interfaces comprise an F1 interface.

14. The method of claim 11, further comprising:
receiving a configuration for mapping the CU to the one or more DUs.

15. The method of claim 11, further comprising, based at least in part on a connection availability between the network node and a DU of the one or more DUs, one or more of:
establishing a connection with the DU;
releasing the connection with the DU;
suspending the connection with the DU; or
resuming the connection with the DU.

16. The method of claim 15, wherein the connection availability between the network node and the DU is based at least in part on movement of the DU.

17. A network node for wireless communication, comprising:
one or more memories; and
one or more processors, coupled to the one or more memories, configured to cause the network node to:
establish a network interface link with a centralized unit (CU);
establish a set of one or more network interface links with a set of one or more distributed units (DUs);
receive a first communication via the network interface link;
transmit the first communication to an end node via a first network interface link of the set of one or more network interface links;
receive a second communication via the network interface link; and
transmit, after transmitting the first communication via the first network interface link, the second communication to the end node via a second network interface link.

18. The network node of claim 17, wherein the set of one or more network interface links comprises the second network interface link, or
wherein the second network interface link is established after the set of one or more network interface links is established.

19. The network node of claim 17, wherein the one or more processors, to transmit the second communication to the second DU via the second network interface link, are further configured to cause the network node to:
transmit the second communication to the second DU via the second network interface link based at least in part on one or more of movement or availability of the first DU associated with the first network interface link, availability of the first network interface link, movement or availability of the second DU associated with the second network interface link, or availability of the second network interface link.

20. The network node of claim 17, wherein the one or more processors are further configured to cause the network node to release, suspend, or resume the first network interface link after the first communication is transmitted,
wherein the first network interface link is released, suspended, or resumed based at least in part on a connection availability between the network node and the first DU independent from the network interface link with the CU.

21. The network node of claim 17, wherein the one or more processors are further configured to cause the network node to perform a network interface link setup associated with the second network interface link before transmitting the second communication,
wherein the network interface link setup associated with the second network interface link is independent from the network interface link with the CU.

22. The network node of claim 17, wherein the one or more processors are further configured to cause the network node to:
receive, from the CU, an indication of an intra-DU handover from the first DU associated with the first network interface link to the second DU associated with the second network interface link; and
perform an inter-DU handover from the first DU to the second DU.

23. The network node of claim 17, wherein to perform the inter-DU handover from the first DU to the second DU, the one or more processors are further configured to cause the network node to:
receive, from the first DU, first configuration information associated with a first link between the first DU and the destination node; and
transmit, to the second DU, second configuration information, based at least in part on the first configuration information, associated with establishing a second link between the second DU and the destination node.

24. The network node of claim 17, wherein the set of one or more DUs comprises a set of one or more non-terrestrial network (NTN) DUs.

25. The network node of claim 17, wherein the network interface link and the one or more network interface links comprise F1 interface links.

26. A network node for wireless communication, comprising:
one or more memories; and
one or more processors, coupled to the one or more memories, configured to cause the network node to:
communicate with a centralized unit (CU);
communicate with a set of one or more distributed units (DUs);
receive, from the CU, an indication of a handover from a first cell associated with a first DU to a second cell associated with a second DU;
transmit, to the first DU, an indication of a user equipment (UE) context modification request associated with the first cell;
receive, from the first DU, an indication of a UE context modification response;
transmit, to the second DU, an indication of a UE context setup request associated with the second cell; and
receive, from the second DU, an indication of a UE context setup response.

27. The network node of claim 26, wherein the one or more processors are further configured to cause the network node to:
establish network interfaces with the CU and with the one or more DUs.

28. The network node of claim 26, wherein the one or more processors are further configured to cause the network node to:
receive a configuration for mapping the CU to the one or more DUs.

29. The network node of claim 26, wherein the one or more processors are further configured to cause the network node to, based at least in part on a connection availability between the network node and a DU of the one or more DUs, one or more of:
establish a connection with the DU;
release the connection with the DU;
suspend the connection with the DU; or
resume the connection with the DU.

30. The network node of claim 29, wherein the connection availability between the network node and the DU is based at least in part on movement of the DU.
